(19) United States
(12) Patent Application Publication
(10) Pub. No.: US 2019/0185367 A1
(43) Pub. Date: Jun. 20, 2019

(54) METHOD AND APPARATUS FOR LAMINATED BACKLIGHT UNIT

(71) Applicant: CORNING INCORPORATED, CORNING, NY (US)

(72) Inventors: Sergey Anatol'evich Kuchinsky, St. Petersburg (RU); Shenping Li, Painted Post, NY (US); Steven S Rosenblum, Ithaca, NY (US); James Andrew West, Painted Post, NY (US)

(21) Appl. No.: 16/324,786

(22) PCT Filed: Aug. 11, 2017
(86) PCT No.: PCT/US2017/046510

§ 371 Date: Feb. 11, 2019

Related U.S. Application Data
(60) Provisional application No. 62/373,611, filed on Aug. 11, 2016.

(51) Int. Cl. C03C 3/087; C03C 3/078; C03C 3/093; F21V 8/00

(52) U.S. Cl. CPC C03C 3/087; C03C 3/078; G02B 6/0088; G02B 6/0065; C03C 3/093

(57) ABSTRACT

A backlight unit comprising a first optical component having a first major face and a second major face, a second optical component laminated having a third major face and a fourth major face, wherein the first and third major faces oppose each other, and a discontinuous bonding material deposited between the first and third major faces, the bonding material laminating the first and second optical components.

### CROSS-REFERENCE TO RELATED APPLICATIONS

This application claims the benefit of priority under 35 U.S.C. § 119 of U.S. Provisional Application Ser. No. 62/373,611 filed on Aug. 11, 2016, the content of which is relied upon and incorporated herein by reference in its entirety.

### BACKGROUND

Conventional side lit back light units include a light guide plate (LGP) that is usually made of high transmission plastic materials such as polymethylmethacrylate (PMMA). Although such plastic materials present excellent properties such as light transmission, these materials exhibit relatively poor mechanical properties such as rigidity, coefficient of thermal expansion (CTE) and moisture absorption.

Light guide plates (LGPs) can be used in edge-lit LCD TVs to distribute light from a one dimensional line of LED illuminators into a uniform 2D surface illumination system across an entire LCD panel. The LGP, along with the LEDs, rear reflector, brightness enhancing film(s) (BEF), diffuser(s), and dual brightness enhancing film (DBEF, or reflecting polarizer) generally comprise an exemplary LCD backlight unit (BLU). In conventional backlight units, the light from an LED strip is coupled from one edge (or two edges) into a LGP, and the LGP must produce uniform distribution of light in both color and brightness across its surface.

An advantage of an edge-lit BLU is that it enables the slim design of LCD TVs. The trend of replacement of polymer LGPs by glass LGPs makes this feature more pronounced because of the unique properties of glass, such as but not limited to, low optical attenuation, low coefficient of thermal expansion, and good mechanical strength. The mechanical strength of glass enables the LGP to perform light distribution functions but also as the frame of a LCD display which enables the elimination of the metal frame required for polymer LGP based displays. For various reasons, such as rigidity, thickness, and manufacturing simplification it may be desirable to laminate different layers such as diffusers, TFT backplanes, and rear reflectors to glass LGPs. However, conventional lamination methods cause significant degradation of the optical performance of LGPs and some optical films (such as, BEF, DBEF, or reflecting polarizer) since the lack of an air/glass interface affects total internal reflection.

Accordingly, it would be desirable to provide an improved light guide plate and backlight unit containing such a light guide plate that achieves an improved optical performance in terms of light transmission, solarization, scattering and light coupling as well as exhibiting exceptional mechanical performance in terms of rigidity, CTE, and moisture absorption. It would also be desirable to provide a lamination method which minimizes the impact of the lamination on the optical performance of LGP and optical films.

### SUMMARY

Aspects of the subject matter pertain to compounds, compositions, articles, devices, and methods for the manufacture of light guide plates and back light units including such light guide plates made from glass. In some embodiments, light guide plates (LGPs) are provided that have similar or superior optical properties to light guide plates made from PMMA and that have exceptional mechanical properties such as rigidity, CTE and dimensional stability in high moisture conditions as compared to PMMA light guide plates.

Principles and embodiments of the present subject matter relate in some embodiments to a light guide plate for use in a backlight unit. In some embodiments a backlight unit can include the glass article or light guide plate (in some examples) having a glass sheet with a front face having a width and a height, a back face opposite the front face, and a thickness between the front face and back face, forming four edges around the front and back faces.

Additional embodiments include a method which enables lamination of different components together in a backlight unit while minimizing the impact of the lamination on the optical performance of the optical components in the backlight unit. In some embodiments, the method includes depositing discontinuous bonding dots with a proper refractive index to laminate two components together. The bonding dots can be uniformly or non-uniformly distributed over the interface between the two components. The bonding materials can be optically clear adhesives (OCAs), frit, or any other suitable materials which have proper refractive indices and bonding properties.

Some embodiments described herein are directed to a method of manufacturing a backlight unit comprising the steps of providing a first optical component having a first major face and a second major face and laminating the first optical component to a third major face of a second optical component using a discontinuous bonding material, the third major face opposing the first major face of the first optical component. In some embodiments, the first optical component is a light guide plate. In some embodiments, the light guide plate comprises a glass or glass-ceramic material. In some embodiments, the glass or glass-ceramic material comprises between about 65.79 mol % to about 78.17 mol % SiO₂, between about 2.94 mol % to about 12.12 mol % Al₂O₃, between about 0 mol % to about 11.16 mol % B₂O₃, between about 0 mol % to about 2.06 mol % Li₂O, between about 3.52 mol % to about 13.25 mol % Na₂O, between about 0 mol % to about 4.83 mol % K₂O, between about 0 mol % to about 3.01 mol % ZnO, between about 0 mol % to about 8.72 mol % MgO, between about 0 mol % to about 4.24 mol % CaO, between about 0 mol % to about 6.17 mol % SrO, between about 0 mol % to about 4.3 mol % BaO, and between about 0.07 mol % to about 0.11 mol % SnO₂. In some embodiments, the glass or glass-ceramic material comprises between about 66 mol % to about 78 mol % SiO₂, between about 4 mol % to about 11 mol % Al₂O₃, between about 4 mol % to about 11 mol % B₂O₃, between about 0 mol % to about 2 mol % Li₂O, between about 4 mol % to about 12 mol % Na₂O, between about 0 mol % to about 2 mol % K₂O, between about 0 mol % to about 2 mol % ZnO, between about 0 mol % to about 5 mol % MgO, between about 0 mol % to about 2 mol % CaO, between about 0 mol % to about 5 mol % SrO, between about 0 mol % to about 2 mol % BaO, and between about 0 mol % to about 2 mol % SnO₂. In some embodiments, the glass or glass-ceramic material comprises between about 72 mol % to about 80 mol % SiO₂, between about 3 mol % to about 7 mol % Al₂O₃, between about 0 mol % to about 2 mol % B₂O₃, between about 0 mol % to about 2 mol % Li₂O, between about 6 mol % to about 15 mol % Na₂O, between about 0 mol % to about 2 mol % K₂O, between about 0 mol % to about 2 mol % ZnO, between about 2 mol % to about 10 mol % MgO, between about 0 mol % to about 2 mol % CaO, between about 0 mol % to about 2 mol % SrO, between about 0 mol % to about 2 mol % BaO, and between about 0 mol % to about 2 mol % SnO₂. In some embodiments, the glass or glass-ceramic material comprises between about 60 mol % to about 80 mol % SiO₂, between about 0 mol % to about 15 mol % Al₂O₃, between about 0 mol % to about 15 mol % B₂O₃, and about 2 mol % to about 50 mol % RₓO, wherein R is any one or more of Li, Na, K, Rb, Cs and x is 2, or Zn, Mg, Ca, Sr or Ba and x is 1, and wherein Fe+30Cr+35Ni<about 60 ppm. In some embodiments, the glass or glass-ceramic material comprises between about 60 mol % to about 80 mol % SiO₂, between about 0 mol % to about 15 mol % Al₂O₃, between about 0 mol % to about 15 mol % B₂O₃, and about 2 mol % to about 50 mol % RₓO, wherein R is any one or more of Li, Na, K, Rb, Cs and x is 2, or Zn, Mg, Ca, Sr or Ba and x is 1, and wherein the glass has a color shift <0.005. In some embodiments, the glass or glass-ceramic material comprises between about 60 mol % to about 81 mol % SiO₂, between about 0 mol % to about 2 mol % Al₂O₃, between about 0 mol % to about 15 mol % MgO, between about 0 mol % to about 2 mol % Li₂O, between about 9 mol % to about 15 mol % Na₂O, between about 0 mol % to about 1.5 mol % K₂O, between about 7 mol % to about 14 mol % CaO, between about 0 mol % to about 2 mol % SrO, and wherein Fe+30Cr+35Ni<about 60 ppm. In some embodiments, the glass or glass-ceramic material comprises between about 60 mol % to about 81 mol % SiO₂, between about 0 mol % to about 2 mol % Al₂O₃, between about 0 mol % to about 15 mol % MgO, between about 0 mol % to about 2 mol % Li₂O, between about 9 mol % to about 15 mol % Na₂O, between about 0 mol % to about 1.5 mol % K₂O, between about 7 mol % to about 14 mol % CaO, and between about 0 mol % to about 2 mol % SrO, wherein the glass has a color shift <0.005. In some embodiments, the second optical component is a film. In some embodiments, the film is a prism film, a reflective film, a diffusing film, a brightness enhancing film, a polarizing film, or combinations thereof. In some embodiments, the step of laminating includes depositing bonding material in a pattern on the first major face or the third major face, the pattern being a uniform distribution, a non-uniform distribution, or a gradient distribution of bonding material. In some embodiments, the bonding material is an optically clear adhesive or a frit. In some embodiments, the refractive index of the bonding material is smaller than a refractive index of the first optical component. In some embodiments, the refractive index of bonding material is 3% less than a refractive index of the first optical component and total bonding material area which contacts with the first optical component is less than 0.18% of total surface area of the first major face. In some embodiments, the refractive index of bonding material is 6% less than a refractive index of the first optical component and total bonding material area which contacts with the first optical component is less than 0.25% of total surface area of the first major face. In some embodiments, the refractive index of bonding material is 10% less than a refractive index of the first optical component and total bonding material area which contacts with the first optical component is less than 0.45% of total surface area of the first major face. In some embodiments, the refractive index of bonding material is 13% less than a refractive index of the first optical component and total bonding material area which contacts with the first optical component is less than 1.4% of the total surface area of the first major face.

Further embodiments described herein are directed to a backlight unit comprising a first optical component having a first major face and a second major face, a second optical component laminated having a third major face and a fourth major face, wherein the first and third major faces oppose each other, and a discontinuous bonding material deposited between the first and third major faces, the bonding material laminating the first and second optical components. In some embodiments, the first optical component is a light guide plate. In some embodiments, light guide plate comprises a glass or glass-ceramic material. In some embodiments, the glass or glass-ceramic material comprises between about 65.79 mol % to about 78.17 mol % SiO₂, between about 2.94 mol % to about 12.12 mol % Al₂O₃, between about 0 mol % to about 11.16 mol % B₂O₃, between about 0 mol % to about 2.06 mol % Li₂O, between about 3.52 mol % to about 13.25 mol % Na₂O, between about 0 mol % to about 4.83 mol % K₂O, between about 0 mol % to about 3.01 mol % ZnO, between about 0 mol % to about 8.72 mol % MgO, between about 0 mol % to about 4.24 mol % CaO, between about 0 mol % to about 6.17 mol % SrO, between about 0 mol % to about 4.3 mol % BaO, and between about 0.07 mol % to about 0.11 mol % SnO₂. In some embodiments, the glass or glass-ceramic material comprises between about 66 mol % to about 78 mol % SiO₂, between about 4 mol % to about 11 mol % Al₂O₃, between about 4 mol % to about 11 mol % B₂O₃, between about 0 mol % to about 2 mol % Li₂O, between about 4 mol % to about 12 mol % Na₂O, between about 0 mol % to about 2 mol % K₂O, between about 0 mol % to about 2 mol % ZnO, between about 0 mol % to about 5 mol % MgO, between about 0 mol % to about 2 mol % CaO, between about 0 mol % to about 5 mol % SrO, between about 0 mol % to about 2 mol % BaO, and between about 0 mol % to about 2 mol % SnO₂. In some embodiments, the glass or glass-ceramic material comprises between about 72 mol % to about 80 mol % SiO₂, between about 3 mol % to about 7 mol % Al₂O₃, between about 0 mol % to about 2 mol % B₂O₃, between about 0 mol % to about 2 mol % Li₂O, between about 6 mol % to about 15 mol % Na₂O, between about 0 mol % to about 2 mol % K₂O, between about 0 mol % to about 2 mol % ZnO, between about 2 mol % to about 10 mol % MgO, between about 0 mol % to about 2 mol % CaO, between about 0 mol % to about 2 mol % SrO, between about 0 mol % to about 2 mol % BaO, and between about 0 mol % to about 2 mol % SnO₂. In some embodiments, the glass or glass-ceramic material comprises between about 60 mol % to about 80 mol % SiO₂, between about 0 mol % to about 15 mol % Al₂O₃, between about 0 mol % to about 15 mol % B₂O₃, and about 2 mol % to about 50 mol % RₓO, wherein R is any one or more of Li, Na, K, Rb, Cs and x is 2, or Zn, Mg, Ca, Sr or Ba and x is 1, and wherein Fe+30Cr+35Ni<about 60 ppm. In some embodiments, the glass or glass-ceramic material comprises between about 60 mol % to about 80 mol % SiO₂, between about 0 mol % to about 15 mol % Al₂O₃, between about 0 mol % to about 15 mol % B₂O₃, and about 2 mol % to about 50 mol % RₓO, wherein R is any one or more of Li, Na, K, Rb, Cs and x is 2, or Zn, Mg, Ca, Sr or Ba and x is 1, and wherein the glass has a color shift <0.005. In some embodiments, the glass or glass-ceramic material comprises between about 60 mol % to about 81 mol % SiO₂, between about 0 mol % to about 2 mol % Al₂O₃, between about 0 mol % to about 15 mol % MgO, between about 0 mol % to about 2 mol % Li₂O, between about 9 mol % to about 15 mol % Na₂O, between about 0 mol % to about 1.5 mol % K₂O, between about 7 mol % to about 14 mol % CaO, between about 0 mol % to about 2 mol % SrO, and wherein Fe+30Cr+35Ni<about 60 ppm. In some embodiments, the glass or glass-ceramic material comprises between about 60 mol % to about 81 mol % SiO₂, between about 0 mol % to about 2 mol % Al₂O₃, between about 0 mol % to about 15 mol % MgO, between about 0 mol % to about 2 mol % Li₂O, between about 9 mol % to about 15 mol % Na₂O, between about 0 mol % to about 1.5 mol % K₂O, between about 7 mol % to about 14 mol % CaO, and between about 0 mol % to about 2 mol % SrO, wherein the glass has a color shift <0.005. In some embodiments, the second optical component is a film. In some embodiments, the film is a prism film, a reflective film, a diffusing film, a brightness enhancing film, a polarizing film, or combinations thereof. In some embodiments, the discontinuous bonding material is contained in a uniform distribution, a non-uniform distribution, or a gradient distribution between the first and third major faces. In some embodiments, the bonding material is an optically clear adhesive or a frit. In some embodiments, the refractive index of the bonding material is smaller than a refractive index of the first optical component. In some embodiments, the refractive index of bonding material is 3% less than a refractive index of the first optical component and total bonding material area which contacts with the first optical component is less than 0.18% of total surface area of the first major face. In some embodiments, the refractive index of bonding material is 6% less than a refractive index of the first optical component and total bonding material area which contacts with the first optical component is less than 0.25% of total surface area of the first major face. In some embodiments, the refractive index of bonding material is 10% less than a refractive index of the first optical component and total bonding material area which contacts with the first optical component is less than 0.45% of total surface area of the first major face. In some embodiments, the refractive index of bonding material is 13% less than a refractive index of the first optical component and total bonding material area which contacts with the first optical component is less than 1.4% of the total surface area of the first major face.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be further understood when read in conjunction with the following drawings.

FIG. 1 is a pictorial illustration of an exemplary embodiment of a light guide plate;

FIG. 2 is a graph showing percentage light coupling versus distance between an LED and LGP edge;

FIG. 3 is a graph showing the estimated light leakage in dB/m versus RMS roughness of an LGP;

FIG. 4 is a graph showing an expected coupling (without Fresnel losses) as a function of distance between the LGP and LED for a 2 mm thick LED's coupled into a 2 mm thick LGP;

FIG. 5 is a pictorial illustration of a coupling mechanism from an LED to a glass LGP;

FIG. 6 is a graph showing an expected angular energy distribution calculated from surface topology;

FIG. 7 is a pictorial illustration showing total internal reflection of light at two adjacent edges of a glass LGP;

FIGS. 8A and 8B are simplified cross sectional illustrations of exemplary backlight units with an LGP in accordance with one or more embodiments;

FIG. 9 is a graphical depiction of power coupled from an exemplary LGP to an optical film for some embodiments; and

FIG. 10 is a graphical depiction of power coupled from an exemplary LGP to an optical film for other embodiments.

### DETAILED DESCRIPTION

Described herein are light guide plates, backlight units, and methods of making light guide plates and backlight units utilizing light guide plates in accordance with embodiments of the present invention.

Conventional light guide plates used in LCD backlight applications are typically made from PMMA material since this is one of the best materials in term of optical transmission in the visible spectrum. However, PMMA presents mechanical problems that make large size (e.g., 50 inch diagonal and greater) displays challenging in term of mechanical design, such as, rigidity, moisture absorption, and coefficient of thermal expansion (CTE).

With regard to rigidity, conventional LCD panels are made of two pieces of thin glass (color filter substrate and TFT substrate) with a PMMA light guide and a plurality of thin plastic films (diffusers, dual brightness enhancement films (DBEF) films, etc.). Due to the poor elastic modulus of PMMA, the overall structure of the LCD panel does not have sufficient rigidity, and additional mechanical structure is necessary to provide stiffness for the LCD panel. It should be noted that PMMA generally has a Young's modulus of about 2 GPa, while certain exemplary glasses have a Young's modulus ranging from about 60 GPa to 90 GPa or more.

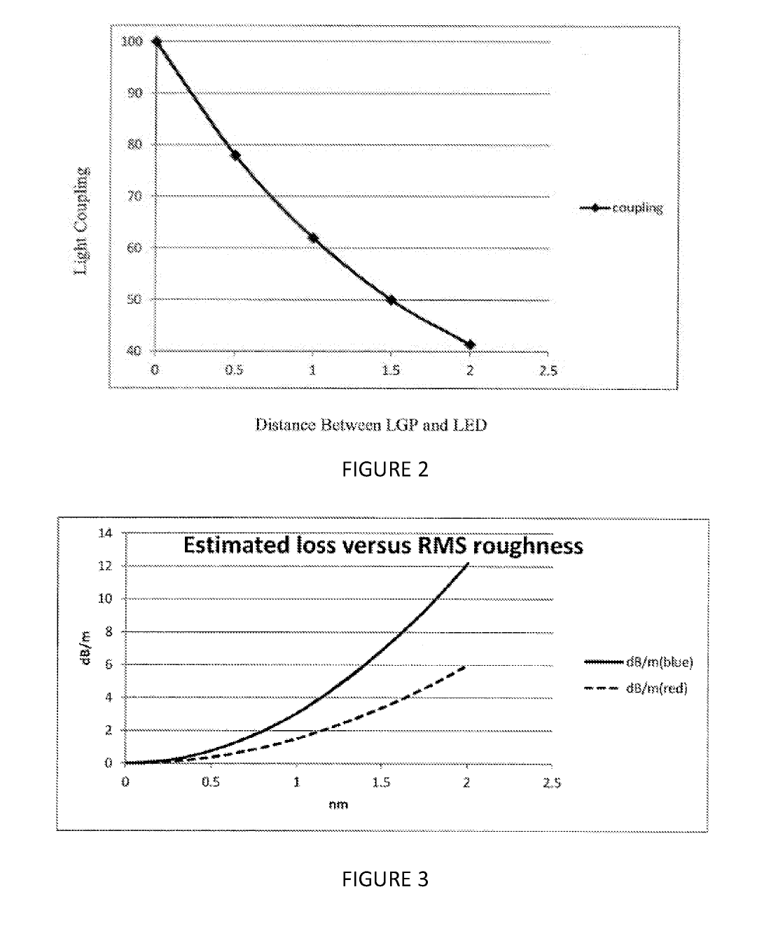

Regarding moisture absorption, humidity testing shows that PMMA is sensitive to moisture and size can change by about 0.5%. For a PMMA panel having a length of one meter, this 0.5% change can increase the length by 5 mm, which is significant and makes the mechanical design of a corresponding backlight unit challenging. Conventional means to solve this problem is leaving an air gap between the light emitting diodes (LEDs) and the PMMA light guide plate (LGP) to let the material expand. A problem with this approach is that light coupling is extremely sensitive to the distance from the LEDs to the LGP, which can cause the display brightness to change as a function of humidity. FIG. 2 is a graph showing percentage light coupling versus distance between an LED and LGP edge. With reference to FIG. 2, a relationship is shown which illustrates the drawbacks of conventional measures to solve challenges with PMMA. More specifically, FIG. 2 illustrates a plot of light coupling versus LED to LGP distance assuming both are 2 mm in height. It can be observed that the further the distance between LED and LGP, a less efficient light coupling is made between the LED and LGP.

With regard to CTE, the CTE of PMMA is about 75E-6 C⁻¹ and has relatively low thermal conductivity (0.2 W/m/K) while some glasses have a CTE of about 8E-6 C⁻¹ and a thermal conductivity of 0.8 W/m/K. Of course, the CTE of other glasses can vary and such a disclosure should not limit the scope of the claims appended herewith. PMMA also has a transition temperature of about 105° C., and when used an LGP, a PMMA LGP material can become very hot whereby its low conductivity makes it difficult to dissipate heat. Accordingly, using glass instead of PMMA as a material for light guide plates provides benefits in this regard, but conventional glass has a relatively poor transmission compared to PMMA due mostly to iron and other impurities. Also some other parameters such as surface roughness, waviness, and edge quality polishing can play a significant role on how a glass light guide plate can perform. According embodiments of the invention, glass light guide plates for use in backlight units can have one or more of the following attributes.

Glass Light Guide Plate Structure and Composition

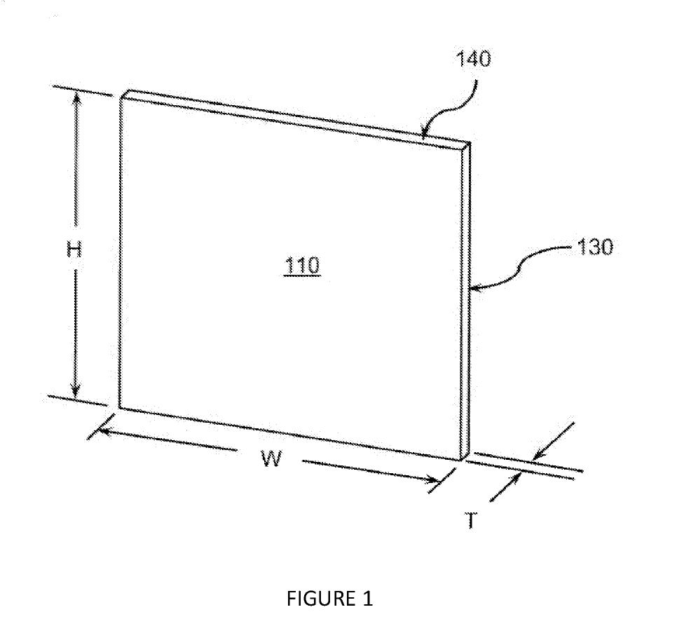

FIG. 1 is a pictorial illustration of an exemplary embodiment of a light guide plate. With reference to FIG. 1, an illustration is provided of an exemplary embodiment having a shape and structure of an exemplary light guide plate comprising a sheet of glass 100 having a first face 110, which may be a front face, and a second face opposite the first face, which may be a back face. The first and second faces may have a height, H, and a width, W. The first and/or second face(s) may have a roughness that is less than 0.6 nm, less than 0.5 nm, less than 0.4 nm, less than 0.3 nm, less than 0.2 nm, less than 0.1 nm, or between about 0.1 nm and about 0.6 nm.

The glass sheet may have a thickness, T, between the front face and the back face, where the thickness forms four edges. The thickness of the glass sheet may be less than the height and width of the front and back faces. In various embodiments, the thickness of the plate may be less than 1.5% of the height of the front and/or back face. Alternatively, the thickness, T, may be less than about 3 mm, less than about 2 mm, less than about 1 mm, or between about 0.1 mm to about 3 mm. The height, width, and thickness of the light guide plate may be configured and dimensioned for use in an LCD backlight application.

A first edge 130 may be a light injection edge that receives light provided for example by a light emitting diode (LED). The light injection edge may scatter light within an angle less than 12.8 degrees full width half maximum (FWHM) in transmission. The light injection edge may be obtained by grinding the edge without polishing the light injection edge. The glass sheet may further comprise a second edge 140 adjacent to the light injection edge and a third edge opposite the second edge and adjacent to the light injection edge, where the second edge and/or the third edge scatter light within an angle of less than 12.8 degrees FWHM in reflection. The second edge 140 and/or the third edge may have a diffusion angle in reflection that is below 6.4 degrees. It should be noted that while the embodiment depicted in FIG. 1 shows a single edge 130 injected with light, the claimed subject matter should not be so limited as any one or several of the edges of an exemplary embodiment 100 can be injected with light. For example, in some embodiments, the first edge 130 and its opposing edge can both be injected with light. Such an exemplary embodiment may be used in a display device having a large and or curvilinear width W. Additional embodiments may inject light at the second edge 140 and its opposing edge rather than the first edge 130 and/or its opposing edge. Thicknesses of exemplary display devices can be less than about 10 mm, less than about 9 mm, less than about 8 mm, less than about 7 mm, less than about 6 mm, less than about 5 mm, less than about 4 mm, less than about 3 mm, or less than about 2 mm.

In various embodiments, the glass composition of the glass sheet may comprise between 60-80 mol % SiO₂, between 0-20 mol % Al₂O₃, and between 0-15 mol % B₂O₃, and less than 50 ppm iron (Fe) concentration. In some embodiments, there may be less than 25 ppm Fe, or in some embodiments the Fe concentration may be about 20 ppm or less.

In various embodiments, the thermal conduction of the light guide plate 100 may be greater than 0.5 W/m/K. In additional embodiments, the glass sheet may be formed by a polished float glass, a fusion draw process, a slot draw process, a redraw process, or another suitable forming process.

In other embodiments, the glass composition of the glass sheet may comprise between 63-81 mol % SiO₂, between 0-5 mol % Al₂O₃, between 0-6 mol % MgO, between 7-14 mol % CaO, between 0-2 mol % Li₂O, between 9-15 mol % Na₂O, between 0-1.5 mol % K₂O, and trace amounts of Fe₂O₃, Cr₂O₃, MnO₂, Co₃O₄, TiO₂, SO₃, and/or Se.

According to one or more embodiments, the LGP can be made from a glass comprising colorless oxide components selected from the glass formers SiO₂, Al₂O₃, and B₂O₃. The exemplary glass may also include fluxes to obtain favorable melting and forming attributes. Such fluxes include alkali oxides (Li₂O, Na₂O, K₂O, Rb₂O and Cs₂O) and alkaline earth oxides (MgO, CaO, SrO, ZnO and BaO). In one embodiment, the glass contains constituents in the range of 60-80 mol % SiO₂, in the range of 0-20 mol % Al₂O₃, in the range of 0-15 mol % B₂O₃, and in the range of 5 and 20% alkali oxides, alkaline earth oxides, or combinations thereof. In other embodiments, the glass composition of the glass sheet may comprise no B₂O₃ and comprise between 63-81 mol % SiO₂, between 0-5 mol % Al₂O₃, between 0-6 mol % MgO, between 7-14 mol % CaO, between 0-2 mol % Li₂O, between 9-15 mol % Na₂O, between 0-1.5 mol % K₂O, and trace amounts of Fe₂O₃, Cr₂O₃, MnO₂, Co₃O₄, TiO₂, SO₃, and/or Se

In some glass compositions described herein, SiO₂ can serve as the basic glass former. In certain embodiments, the concentration of SiO₂ can be greater than 60 mole percent to provide the glass with a density and chemical durability suitable for a display glasses or light guide plate glasses, and a liquidus temperature (liquidus viscosity), which allows the glass to be formed by a downdraw process (e.g., a fusion process). In terms of an upper limit, in general, the SiO₂ concentration can be less than or equal to about 80 mole percent to allow batch materials to be melted using conventional, high volume, melting techniques, e.g., Joule melting in a refractory melter. As the concentration of SiO₂ increases, the 200 poise temperature (melting temperature) generally rises. In various applications, the SiO₂ concentration is adjusted so that the glass composition has a melting temperature less than or equal to 1,750° C. In various embodiments, the mol % of SiO₂ may be in the range of about 60% to about 81%, or alternatively in the range of about 66% to about 78%, or in the range of about 72% to about 80%, or in the range of about 65% to about 79%, and all subranges therebetween. In additional embodiments, the mol % of SiO₂ may be between about 70% to about 74%, or between about 74% to about 78%. In some embodiments, the mol % of SiO₂ may be about 72% to 73%. In other embodiments, the mol % of SiO₂ may be about 76% to 77%.

Al₂O₃ is another glass former used to make the glasses described herein. Higher mole percent Al₂O₃ can improve the glass's annealing point and modulus. In various embodiments, the mol % of Al₂O₃ may be in the range of about 0% to about 20%, or alternatively in the range of about 4% to about 11%, or in the range of about 6% to about 8%, or in the range of about 3% to about 7%, and all subranges therebetween. In additional embodiments, the mol % of Al₂O₃ may be between about 4% to about 10%, or between about 5% to about 8%. In some embodiments, the mol % of Al₂O₃ may be about 7% to 8%. In other embodiments, the mol % of Al₂O₃ may be about 5% to 6%, or from 0% to about 5% or from 0% to about 2%.

B₂O₃ is both a glass former and a flux that aids melting and lowers the melting temperature. It has an impact on both liquidus temperature and viscosity. Increasing B₂O₃ can be used to increase the liquidus viscosity of a glass. To achieve these effects, the glass compositions of one or more embodiments may have B₂O₃ concentrations that are equal to or greater than 0.1 mole percent; however, some compositions may have a negligible amount of B₂O₃. As discussed above with regard to SiO₂, glass durability is very important for display applications. Durability can be controlled somewhat by elevated concentrations of alkaline earth oxides, and significantly reduced by elevated B₂O₃ content. Annealing point decreases as B₂O₃ increases, so it may be helpful to keep B₂O₃ content low. Thus, in various embodiments, the mol % of B₂O₃ may be in the range of about 0% to about 15%, or alternatively in the range of about 0% to about 12%, or in the range of about 0% to about 11%, in the range of about 3% to about 7%, or in the range of about 0% to about 2%, and all subranges therebetween. In some embodiments, the mol % of B₂O₃ may be about 7% to 8%. In other embodiments, the mol % of B₂O₃ may be negligible or about 0% to 1%.

In addition to the glass formers (SiO₂, Al₂O₃, and B₂O₃), the glasses described herein also include alkaline earth oxides. In one embodiment, at least three alkaline earth oxides are part of the glass composition, e.g., MgO, CaO, and BaO, and, optionally, SrO. The alkaline earth oxides provide the glass with various properties important to melting, fining, forming, and ultimate use. Accordingly, to improve glass performance in these regards, in one embodiment, the (MgO+CaO+SrO+BaO)/Al₂O₃ ratio is between 0 and 2.0. As this ratio increases, viscosity tends to increase more strongly than liquidus temperature, and thus it is increasingly difficult to obtain suitably high values for T₃₅ₖ−T_{liq}. Thus in another embodiment, ratio (MgO+CaO+SrO+BaO)/Al₂O₃ is less than or equal to about 2. In some embodiments, the (MgO+CaO+SrO+BaO)/A₂O₃ ratio is in the range of about 0 to about 1.0, or in the range of about 0.2 to about 0.6, or in the range of about 0.4 to about 0.6. In detailed embodiments, the (MgO+CaO+SrO+BaO)/A₂O₃ ratio is less than about 0.55 or less than about 0.4.

For certain embodiments of this disclosure, the alkaline earth oxides may be treated as what is in effect a single compositional component. This is because their impact upon viscoelastic properties, liquidus temperatures and liquidus phase relationships are qualitatively more similar to one another than they are to the glass forming oxides SiO₂, Al₂O₃ and B₂O₃. However, the alkaline earth oxides CaO, SrO and BaO can form feldspar minerals, notably anorthite (CaAl₂Si₂O₈) and celsian (BaAl₂Si₂O₈) and strontium-bearing solid solutions of same, but MgO does not participate in these crystals to a significant degree. Therefore, when a feldspar crystal is already the liquidus phase, a superaddition of MgO may serves to stabilize the liquid relative to the crystal and thus lower the liquidus temperature. At the same time, the viscosity curve typically becomes steeper, reducing melting temperatures while having little or no impact on low-temperature viscosities.

The inventors have found that the addition of small amounts of MgO may benefit melting by reducing melting temperatures, forming by reducing liquidus temperatures and increasing liquidus viscosity, while preserving high annealing points. In various embodiments, the glass composition comprises MgO in an amount in the range of about 0 mol % to about 10 mol %, or in the range of about 0 mol % to about 6 mol %, or in the range of about 1.0 mol % to about 8.0 mol %, or in the range of about 0 mol % to about 8.72 mol %, or in the range of about 1.0 mol % to about 7.0 mol %, or in the range of about 0 mol % to about 5 mol %, or in the range of about 1 mol % to about 3 mol %, or in the range of about 2 mol % to about 10 mol %, or in the range of about 4 mol % to about 8 mol %, and all subranges therebetween.

Without being bound by any particular theory of operation, it is believed that calcium oxide present in the glass composition can produce low liquidus temperatures (high liquidus viscosities), high annealing points and moduli, and CTE's in the most desired ranges for display and light guide plate applications. It also contributes favorably to chemical durability, and compared to other alkaline earth oxides, it is relatively inexpensive as a batch material. However, at high concentrations, CaO increases the density and CTE. Furthermore, at sufficiently low SiO₂ concentrations, CaO may stabilize anorthite, thus decreasing liquidus viscosity. Accordingly, in one or more embodiment, the CaO concentration can be between 0 and 6 mol %. In various embodiments, the CaO concentration of the glass composition is in the range of about 0 mol % to about 4.24 mol %, or in the range of about 0 mol % to about 2 mol %, or in the range of about 0 mol % to about 1 mol %, or in the range of about 0 mol % to about 0.5 mol %, or in the range of about 0 mol % to about 0.1 mol %, and all subranges therebetween. In other embodiments, the CaO concentration of the glass composition is in the range of about 7-14 mol %, or from about 9-12 mol %.

SrO and BaO can both contribute to low liquidus temperatures (high liquidus viscosities). The selection and concentration of these oxides can be selected to avoid an increase in CTE and density and a decrease in modulus and annealing point. The relative proportions of SrO and BaO can be balanced so as to obtain a suitable combination of physical properties and liquidus viscosity such that the glass can be formed by a downdraw process. In various embodiments, the glass comprises SrO in the range of about 0 to about 8.0 mol %, or between about 0 mol % to about 4.3 mol %, or about 0 to about 5 mol %, 1 mol % to about 3 mol/%, or about less than about 2.5 mol %, and all subranges therebetween. In one or more embodiments, the glass comprises BaO in the range of about 0 to about 5 mol %, or between 0 to about 4.3 mol %, or between 0 to about 2.0 mol %, or between 0 to about 1.0 mol %, or between 0 to about 0.5 mol %, and all subranges therebetween.

In addition to the above components, the glass compositions described herein can include various other oxides to adjust various physical, melting, fining, and forming attributes of the glasses. Examples of such other oxides include, but are not limited to, TiO₂, MnO, V₂O₃, Fe₂O₃, ZrO₂, ZnO, Nb₂O₅, MoO₃, Ta₂O₅, WO₃, Y₂O₃, La₂O₃ and CeO₂ as well as other rare earth oxides and phosphates. In one embodiment, the amount of each of these oxides can be less than or equal to 2.0 mole percent, and their total combined concentration can be less than or equal to 5.0 mole percent. In some embodiments, the glass composition comprises ZnO in an amount in the range of about 0 to about 3.5 mol %, or about 0 to about 3.01 mol %, or about 0 to about 2.0 mol %, and all subranges therebetween. In other embodiments, the glass composition comprises from about 0.1 mol % to about 1.0 mol % titanium oxide; from about 0.1 mol % to about 1.0 mol % vanadium oxide; from about 0.1 mol % to about 1.0 mol % niobium oxide; from about 0.1 mol % to about 1.0 mol % manganese oxide; from about 0.1 mol % to about 1.0 mol % zirconium oxide; from about 0.1 mol % to about 1.0 mol % tin oxide; from about 0.1 mol % to about 1.0 mol % molybdenum oxide; from about 0.1 mol % to about 1.0 mol % cerium oxide; and all subranges therebetween of any of the above listed transition metal oxides. The glass compositions described herein can also include various contaminants associated with batch materials and/or introduced into the glass by the melting, fining, and/or forming equipment used to produce the glass. The glasses can also contain SnO₂ either as a result of Joule melting using tin-oxide electrodes and/or through the batching of tin containing materials, e.g., SnO₂, SnO, SnCO₃, SnC₂O₂, etc.

The glass compositions described herein can contain some alkali constituents, e.g., these glasses are not alkali-free glasses. As used herein, an “alkali-free glass” is a glass having a total alkali concentration which is less than or equal to 0.1 mole percent, where the total alkali concentration is the sum of the Na₂O, K₂O, and Li₂O concentrations. In some embodiments, the glass comprises Li₂O in the range of about 0 to about 3.0 mol %, in the range of about 0 to about 3.01 mol %, in the range of about 0 to about 2.0 mol %, in the range of about 0 to about 1.0 mol %, less than about 3.01 mol %, or less than about 2.0 mol %, and all subranges therebetween. In other embodiments, the glass comprises Na₂O in the range of about 3.5 mol % to about 13.5 mol %, in the range of about 3.52 mol % to about 13.25 mol %, in the range of about 4 to about 12 mol %, in the range of about 6 to about 15 mol %, or in the range of about 6 to about 12 mol %, in the range of about 9 mol % to about 15 mol %, and all subranges therebetween. In some embodiments, the glass comprises K₂O in the range of about 0 to about 5.0 mol %, in the range of about 0 to about 4.83 mol %, in the range of about 0 to about 2.0 mol %, in the range of about 0 to about 1.5 mol %, in the range of about 0 to about 1.0 mol %, or less than about 4.83 mol %, and all subranges therebetween.

In some embodiments, the glass compositions described herein can have one or more or all of the following compositional characteristics: (i) an As₂O₃ concentration of at most 0.05 to 1.0 mol %; (ii) an Sb₂O₃ concentration of at most 0.05 to 1.0 mol %; (iii) a SnO₂ concentration of at most 0.25 to 3.0 mol %.

As₂O₃ is an effective high temperature fining agent for display glasses, and in some embodiments described herein, As₂O₃ is used for fining because of its superior fining properties. However, As₂O₃ is poisonous and requires special handling during the glass manufacturing process. Accordingly, in certain embodiments, fining is performed without the use of substantial amounts of As₂O₃, i.e., the finished glass has at most 0.05 mole percent As₂O₃. In one embodiment, no As₂O₃ is purposely used in the fining of the glass. In such cases, the finished glass will typically have at most 0.005 mole percent As₂O₃ as a result of contaminants present in the batch materials and/or the equipment used to melt the batch materials.

Although not as toxic as As₂O₃, Sb₂O₃ is also poisonous and requires special handling. In addition, Sb₂O₃ raises the density, raises the CTE, and lowers the annealing point in comparison to glasses that use As₂O₃ or SnO₂ as a fining agent. Accordingly, in certain embodiments, fining is performed without the use of substantial amounts of Sb₂O₃, i.e., the finished glass has at most 0.05 mole percent Sb₂O₃. In another embodiment, no Sb₂O₃ is purposely used in the fining of the glass. In such cases, the finished glass will typically have at most 0.005 mole percent Sb₂O₃ as a result of contaminants present in the batch materials and/or the equipment used to melt the batch materials.

Compared to As₂O₃ and Sb₂O₃ fining, tin fining (i.e., SnO₂ fining) is less effective, but SnO₂ is a ubiquitous material that has no known hazardous properties. Also, for many years, SnO₂ has been a component of display glasses through the use of tin oxide electrodes in the Joule melting of the batch materials for such glasses. The presence of SnO₂ in display glasses has not resulted in any known adverse effects in the use of these glasses in the manufacture of liquid crystal displays. However, high concentrations of SnO₂ are not preferred as this can result in the formation of crystalline defects in display glasses. In one embodiment, the concentration of SnO₂ in the finished glass is less than or equal to 0.25 mole percent, in the range of about 0.07 to about 0.11 mol %, in the range of about 0 to about 2 mol %, from about 0 to about 3 mol %, and all subranges therebetween.

Tin fining can be used alone or in combination with other fining techniques if desired. For example, tin fining can be combined with halide fining, e.g., bromine fining. Other possible combinations include, but are not limited to, tin fining plus sulfate, sulfide, cerium oxide, mechanical bubbling, and/or vacuum fining. It is contemplated that these other fining techniques can be used alone. In certain embodiments, maintaining the (MgO+CaO+SrO+BaO)/Al₂O₃ ratio and individual alkaline earth concentrations within the ranges discussed above makes the fining process easier to perform and more effective.

In various embodiments, the glass may comprise RₓO where R is Li, Na, K, Rb, Cs, and x is 2, or R is Zn, Mg, Ca, Sr or Ba, and x is 1. In some embodiments, RₓO—Al₂O₃>0. In other embodiments, 0<RₓO—Al₂O₃<15. In some embodiments, R.0/Al₂O₃ is between 0 and 10, between 0 and 5, greater than 1, or between 1.5 and 3.75, or between 1 and 6, or between 1.1 and 5.7, and all subranges therebetween. In other embodiments, 0<RₓO—Al₂O₃<15. In further embodiments, x=2 and R₂O—Al₂O₃<15, <5, <0, between −8 and 0, or between −8 and −1, and all subranges therebetween. In additional embodiments, R₂O—Al₂O₃<0. In yet additional embodiments, x=2 and R₂O—Al₂O₃—MgO>−10, >−5, between 0 and −5, between 0 and −2, >−2, between −5 and 5, between −4.5 and 4, and all subranges therebetween. In further embodiments, x=2 and RₓO/Al₂O₃ is between 0 and 4, between 0 and 3.25, between 0.5 and 3.25, between 0.95 and 3.25, and all subranges therebetween. These ratios play significant roles in establishing the manufacturability of the glass article as well as determining its transmission performance. For example, glasses having RₓO—Al₂O₃ approximately equal to or larger than zero will tend to have better melting quality but if RₓO—Al₂O₃ becomes too large of a value, then the transmission curve will be adversely affected. Similarly, if RₓO—Al₂O₃ (e.g., R₂O—Al₂O₃) is within a given range as described above then the glass will likely have high transmission in the visible spectrum while maintaining meltability and suppressing the liquidus temperature of a glass. Similarly, the R₂O—Al₂O₃—MgO values described above may also help suppress the liquidus temperature of the glass.

In one or more embodiments and as noted above, exemplary glasses can have low concentrations of elements that produce visible absorption when in a glass matrix. Such absorbers include transition elements such as Ti, V, Cr, Mn, Fe, Co, Ni and Cu, and rare earth elements with partially-filled f-orbitals, including Ce, Pr, Nd, Sm, Eu, Tb, Dy, Ho, Er and Tm. Of these, the most abundant in conventional raw materials used for glass melting are Fe, Cr and Ni. Iron is a common contaminant in sand, the source of SiO₂, and is a typical contaminant as well in raw material sources for aluminum, magnesium and calcium. Chromium and nickel are typically present at low concentration in normal glass raw materials, but can be present in various ores of sand and must be controlled at a low concentration. Additionally, chromium and nickel can be introduced via contact with stainless steel, e.g., when raw material or cullet is jaw-crushed, through erosion of steel-lined mixers or screw feeders, or unintended contact with structural steel in the melting unit itself. The concentration of iron in some embodiments can be specifically less than 50 ppm, more specifically less than 40 ppm, or less than 25 ppm, and the concentration of Ni and Cr can be specifically less than 5 ppm, and more specifically less than 2 ppm. In further embodiments, the concentration of all other absorbers listed above may be less than 1 ppm for each. In various embodiments the glass comprises 1 ppm or less of Co, Ni, and Cr, or alternatively less than 1 ppm of Co, Ni, and Cr. In various embodiments, the transition elements (V, Cr, Mn, Fe, Co, Ni and Cu) may be present in the glass at 0.1 wt % or less. In some embodiments, the concentration of Fe can be <about 50 ppm, <about 40 ppm, <about 30 ppm, <about 20 ppm, or <about 10 ppm. In other embodiments, Fe+30Cr+35Ni<about 60 ppm, <about 50 ppm, <about 40 ppm, <about 30 ppm, <about 20 ppm, or <about 10 ppm.

In other embodiments, it has been discovered that the addition of certain transition metal oxides that do not cause absorption from 300 nm to 650 nm and that have absorption bands <about 300 nm will prevent network defects from forming processes and will prevent color centers (e.g., absorption of light from 300 nm to 650 nm) post UV exposure when curing ink since the bond by the transition metal oxide in the glass network will absorb the light instead of allowing the light to break up the fundamental bonds of the glass network. Thus, exemplary embodiments can include any one or combination of the following transition metal oxides to minimize UV color center formation: from about 0.1 mol % to about 3.0 mol % zinc oxide; from about 0.1 mol % to about 1.0 mol % titanium oxide; from about 0.1 mol % to about 1.0 mol % vanadium oxide; from about 0.1 mol % to about 1.0 mol % niobium oxide; from about 0.1 mol % to about 1.0 mol % manganese oxide; from about 0.1 mol % to about 1.0 mol % zirconium oxide; from about 0.1 mol % to about 1.0 mol % arsenic oxide; from about 0.1 mol % to about 1.0 mol % tin oxide; from about 0.1 mol % to about 1.0 mol % molybdenum oxide; from about 0.1 mol % to about 1.0 mol % antimony oxide; from about 0.1 mol % to about 1.0 mol % cerium oxide; and all subranges therebetween of any of the above listed transition metal oxides. In some embodiments, an exemplary glass can contain from 0.1 mol % to less than or no more than about 3.0 mol % of any combination of zinc oxide, titanium oxide, vanadium oxide, niobium oxide, manganese oxide, zirconium oxide, arsenic oxide, tin oxide, molybdenum oxide, antimony oxide, and cerium oxide.

Even in the case that the concentrations of transition metals are within the above described ranges, there can be matrix and redox effects that result in undesired absorption. As an example, it is well-known to those skilled in the art that iron occurs in two valences in glass, the +3 or ferric state, and the +2 or ferrous state. In glass, Fe³⁺ produces absorptions at approximately 380, 420 and 435 nm, whereas Fe²⁺ absorbs mostly at IR wavelengths. Therefore, according to one or more embodiments, it may be desirable to force as much iron as possible into the ferrous state to achieve high transmission at visible wavelengths. One non-limiting method to accomplish this is to add components to the glass batch that are reducing in nature. Such components could include carbon, hydrocarbons, or reduced forms of certain metalloids, e.g., silicon, boron or aluminum. However it is achieved, if iron levels were within the described range, according to one or more embodiments, at least 10% of the iron in the ferrous state and more specifically greater than 20% of the iron in the ferrous state, improved transmissions can be produced at short wavelengths. Thus, in various embodiments, the concentration of iron in the glass produces less than 1.1 dB/500 mm of attenuation in the glass sheet. Further, in various embodiments, the concentration of V+Cr+Mn+Fe+Co+Ni+Cu produces 2 dB/500 mm or less of light attenuation in the glass sheet when the ratio (Li₂O+Na₂O+K₂O+Rb₂O+Cs₂O+MgO+ZnO+CaO+SrO+BaO)/Al₂O₃ for borosilicate glass is between 0 and 4.

The valence and coordination state of iron in a glass matrix can also be affected by the bulk composition of the glass. For example, iron redox ratio has been examined in molten glasses in the system SiO₂—K₂O—Al₂O₃ equilibrated in air at high temperature. It was found that the fraction of iron as Fe³⁺ increases with the ratio K₂O/(K₂O+Al₂O₃), which in practical terms will translate to greater absorption at short wavelengths. In exploring this matrix effect, it was discovered that the ratios (Li₂O+Na₂O+K₂O+Rb₂O+Cs₂O)/A₂O₃ and (MgO+CaO+ZnO+SrO+BaO)/A₂O₃ can also be important for maximizing transmission in borosilicate glasses. Thus, for the RₓO ranges described above, transmission at exemplary wavelengths can be maximized for a given iron content. This is due in part to the higher proportion of Fe²⁺, and partially to matrix effects associated with the coordination environment of iron.

### Glass Roughness

FIG. 3 is a graph showing the estimated light leakage in dB/m versus RMS roughness of an LGP. With reference to FIG. 3, it can be shown that surface scattering plays a role in LGPs as light is bouncing many times on the surfaces thereof. The curve depicted in FIG. 3 illustrates light leakage in dB/m as a function of the RMS roughness of the LGP. FIG. 3 shows that, to get below 1 dB/m, the surface quality needs to be better than about 0.6 nm RMS. This level of roughness can be achieved by either using fusion draw process or float glass followed by polishing. Such a model assumes that roughness acts like a Lambertian scattering surface which means that we are only considering high spatial frequency roughness. Therefore, roughness should be calculated by considering the power spectral density and only take into account frequencies that are higher than about 20 microns⁻¹. Surface roughness may be measured by atomic force microscopy (AFM); white light interferometry with a commercial system such as those manufactured by Zygo; or by laser confocal microscopy with a commercial system such as those provided by Keyence. The scattering from the surface may be measured by preparing a range of samples identical except for the surface roughness, and then measuring the internal transmittance of each as described below. The difference in internal transmission between samples is attributable to the scattering loss induced by the roughened surface.

UV Processing

In processing exemplary glass, ultraviolet (UV) light can also be used. For instance, light extraction features are often made by white printing dots on glass and UV is used to dry the ink. Also, extraction features can be made of a polymer layer with some specific structure on it and requires UV exposure for polymerization. It has been discovered that UV exposure of glass can significantly affect transmission. According to one or more embodiments, a filter can be used during glass processing of the glass for an LGP to eliminate all wavelengths below about 400 nm. One possible filter consists in using the same glass as the one that is currently exposed.

Glass Waviness

Glass waviness is somewhat different from roughness in the sense that it is much lower frequency (in the mm or larger range). As such, waviness does not contribute to extracting light since angles are very small but it modifies the efficiency of the extraction features since the efficiency is a function of the light guide thickness. Light extraction efficiency is, in general, inversely proportional to the waveguide thickness. Therefore, to keep high frequency image brightness fluctuations below 5% (which is the human perception threshold that resulted from our sparkle human perception analysis), the thickness of the glass needs to be constant within less than 5%. Exemplary embodiments can have an A-side waviness of less than 0.3 μm, less than 0.2 μm, less than 1 um, less than 0.08 μm, or less than 0.06 um.

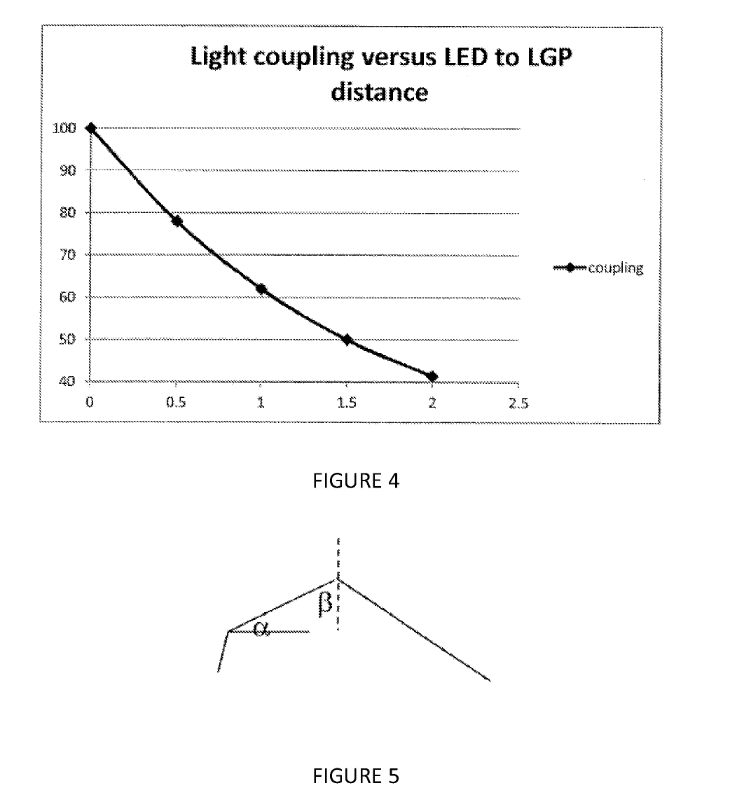

FIG. 4 is a graph showing an expected coupling (without Fresnel losses) as a function of distance between the LGP and LED for a 2 mm thick LED's coupled into a 2 mm thick LGP. With reference to FIG. 4, light injection in an exemplary embodiment usually involves placing the LGP in direct proximity to one or more light emitting diodes (LEDs). According to one or more embodiments, efficient coupling of light from an LED to the LGP involves using LED with a thickness or height that is less than or equal to the thickness of the glass. Thus, according to one or more embodiments, the distance from the LED to the LGP can be controlled to improve LED light injection. FIG. 4 shows the expected coupling (without Fresnel losses) as a function of that distance and considering 2 mm height LED's coupled into a 2 mm thick LGP. According to FIG. 4, the distance should be <about 0.5 mm to keep coupling >about 80%. When plastic such as PMMA is used as a conventional LGP material, putting the LGP in physical contact with the LED's is somewhat problematic. First, a minimum distance is needed to let the material expand. Also LEDs tend to heat up significantly and, in case of physical contact, PMMA can get close to its Tg (105° C. for PMMA). The temperature elevation that was measured when putting PMMA in contact with LED's was about 50° C. close by the LEDs. Thus for PMMA LGP, a minimum air gap is needed which degrades the coupling as shown in FIG. 4. According to embodiments of the subject matter in which glass LGPs are utilized, heating the glass is not a problem since Tg of glass is much higher and physical contact may actually be an advantage since glass has a thermal conduction coefficient that is large enough to make the LGP to be one additional heat dissipation mechanism.

FIG. 5 is a pictorial illustration of a coupling mechanism from an LED to a glass LGP. With reference to FIG. 5, assuming that the LED is close to a lambertian emitter and assuming the glass index of refraction is about 1.5, the angle α will stay smaller than 41.8 degrees (as in (1/1.5)) and the angle β will stay larger than 48.2 degrees (90−α). Since total internal reflection (TIR) angle is about 41.8 degrees, this means that all the light remains internal to the guide and coupling is close to 100%. At the level of the LED injection, the injection face may cause some diffusion which will increase the angle at which light is propagating into the LGP. In the event this angle becomes larger than the TIR angle, light may leak out of the LGP resulting in coupling losses. However, the condition for not introducing significant losses is that the angle in which light gets scattered should be less than 48.2−41.8=+/−6.4 degrees (scattering angle <12.8 degrees). Thus, according to one or more embodiments, a plurality of the edges of the LGP may have a mirror polish to improve LED coupling and TIR. In some embodiments, three of the four edges have a mirror polish. Of course, these angles are exemplary only and should not limit the scope of the claims appended herewith as exemplary scattering angles can be <20 degrees, <19 degrees, <18 degrees, <17 degrees, <16 degrees, <14 degrees, <13 degrees, <12 degrees, <11 degrees, or <10 degrees. Further, exemplary diffusion angles in reflection can be, but are not limited to, <15 degrees, <14 degrees, <13 degrees, <12 degrees, <11 degrees, <10 degrees, <9 degrees, <8 degrees, <7 degrees, <6 degrees, <5 degrees, <4 degrees, or <3 degrees.

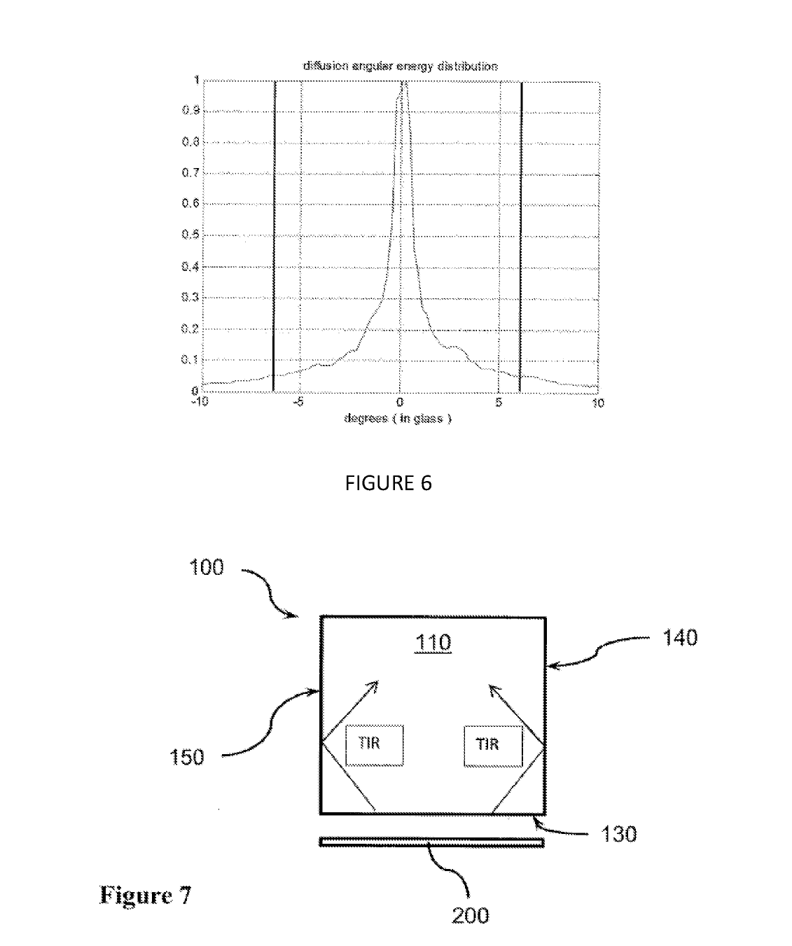

FIG. 6 is a graph showing an expected angular energy distribution calculated from surface topology. With reference to FIG. 6, the typical texture of a grinded only edge is illustrated where roughness amplitude is relatively high (on the order of Inm) but special frequencies are relatively low (on the order of 20 microns) resulting in a low scattering angle. Further, this figure illustrates the expected angular energy distribution calculated from the surface topology. As can be seen, scattering angle can be much less than 12.8 degrees full width half maximum (FWHM).

In terms of surface definition, a surface can be characterized by a local slope distribution θ(x, y) that can be calculated, for instance, by taking the derivative of the surface profile. The angular deflection in the glass can be calculated, in first approximation as:

θ′(x,y)=θ(x,y)/n

Therefore, the condition on the surface roughness is θ(x, y)<n*6.4 degrees with TIR at the 2 adjacent edges.

FIG. 7 is a pictorial illustration showing total internal reflection of light at two adjacent edges of a glass LGP. With reference to FIG. 7, light injected into a first edge 130 can be incident on a second edge 140 adjacent to the injection edge and a third edge 150 adjacent to the injection edge, where the second edge 140 is opposite the third edge 150. The second and third edges may also have a low roughness so that the incident light undergoes total internal reflectance (TIR) from the two edges adjacent the first edge. In the event light is diffused or partially diffused at those interfaces, light may leak from each of those edges, thereby making the edges of an image appear darker. In some embodiments, light may be injected into the first edge 130 from an array of LED's 200 positioned along the first edge 130. The LED's may be located a distance of less than 0.5 mm from the light injection edge. According to one or more embodiments, the LED's may have a thickness or height that is less than or equal to the thickness of the glass sheet to provide efficient light coupling to the light guide plate 100. As discussed with reference to FIG. 1, FIG. 7 shows a single edge 130 injected with light, but the claimed subject matter should not be so limited as any one or several of the edges of an exemplary embodiment 100 can be injected with light. For example, in some embodiments, the first edge 130 and its opposing edge can both be injected with light. Additional embodiments may inject light at the second edge 140 and its opposing edge 150 rather than the first edge 130 and/or its opposing edge. According to one or more embodiments, the two edges 140, 150 may have a diffusion angle in reflection that is below 6.4 degrees such that the condition on the roughness shape is represented by θ(x, y)<6.4/2=3.2 degrees.

LCD Panel Rigidity

One attribute of LCD panels is the overall thickness. In conventional attempts to make thinner structures, lack of sufficient stiffness has become a serious problem Stiffness, however, can be increased with an exemplary glass LGP since the elastic modulus of glass is considerably larger than that of PMMA. In some embodiments, to obtain a maximum benefit from a stiffness point of view, all elements of the panel can be bonded together at the edge.

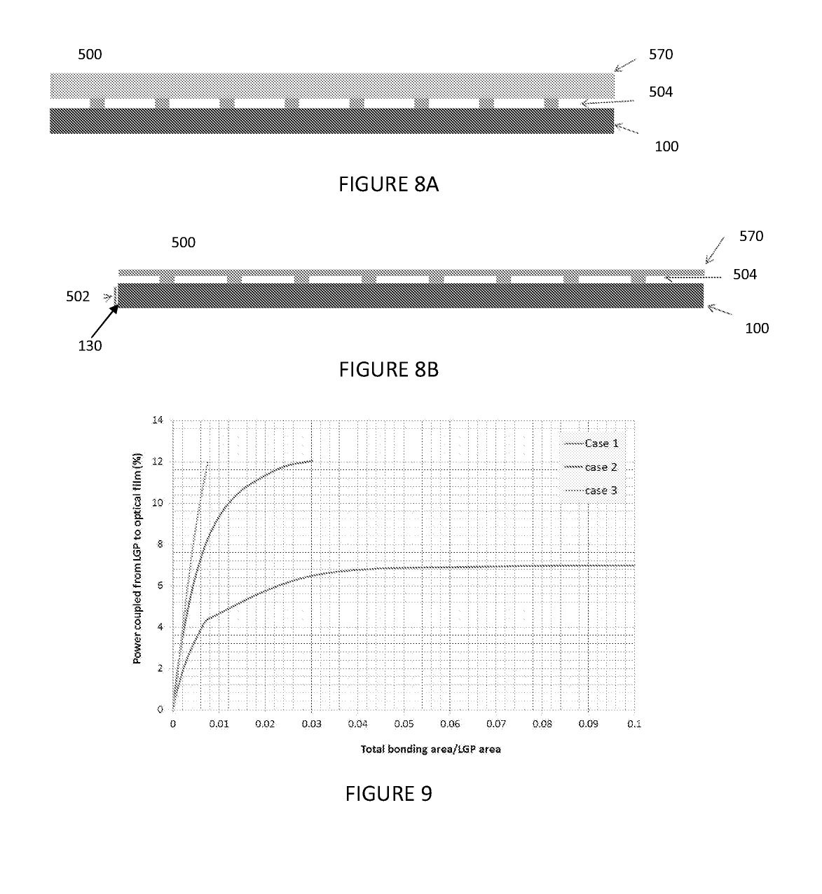

FIGS. 8A and 8B are simplified cross sectional illustrations of exemplary backlight units with a LGP in accordance with one or more embodiments. With reference to FIGS. 8A and 8B, an exemplary embodiment of a backlight unit 500 is provided. The unit comprises a first optical component 100 (e.g., LGP) mounted on a back plate (not shown) through which light can travel and be redirected toward the LCD or an observer. Structural elements (not shown) may affix the first optical component 100 to the back plate, and create a gap between the back face of the first optical component 100 and a face of the back plate. In some embodiments, a reflective and/or diffusing film (not shown) may be positioned between the back face of the first optical component 100 and the back plate to send recycled light back through the first optical component 100. A plurality of LEDs 502, organic light emitting diodes (OLEDs), or cold cathode fluorescent lamps (CCFLs) may be positioned adjacent to the light injection edge 130 of the LGP, where the LEDs have the same width as the thickness of the first optical component 100, and are at the same height as the first optical component 100. In other embodiments, the LEDs have a greater width and/or height as the thickness of the first optical component 100. Conventional LCDs may employ LEDs or CCFLs packaged with color converting phosphors to produce white light. In some embodiments, one or second optical components 570 (e.g., optical film(s)) may be positioned adjacent the front face of the first optical component 100. In some embodiments, the optical film(s) 570 may be laminated to the first optical component 100. To minimize any impact of the lamination on optical performances of the optical components of an exemplary backlight unit 500, discontinuous bonding material 504 with an exemplary refractive index may be used to laminate the two components, e.g., LGP 100 and optical film(s) 570. The bonding material 504 may be distributed in dots, lines, matrixes, or other suitable patterns and can also be uniformly distributed, non-uniformly distributed, distributed by an increasing gradient from the light injection edge 130, distributed by a decreasing gradient from the light injection edge 130, or other suitable distributions over the interface between the two components (in this embodiment, an LGP 100 and film 570). An exemplary lamination or construction balances the refractive index of the bonding material 504 and the contact area on a major surface of the first optical component 100.

For example, it has been discovered that an acceptable optical performance can be achieved with a bonding material having a refractive index 3% less than that of the first optical component 100 and the total area of bonding material contacting the first optical component 100 is less than 0.18% of the total surface area of the first optical component 100. In other embodiments, it was determined that acceptable optical performance of the backlight unit was achieved when the refractive index of the bonding material is 6% less than that of the first optical component 100 and the total area of bonding material which contacts with the first optical component 100 is preferred to be less than 0.25% of the total surface area of the first optical component 100. In further embodiments, it was determined that an acceptable optical performance of the backlight unit was achieved when a refractive index of bonding material was 10% less than that of the first optical component and the total area of bonding material which contacts with the first optical component is less than 0.45% of the total surface area of the first optical component. In additional embodiments, it was determined that acceptable optical performance of the backlight unit was achieved when the refractive index of bonding material was 13% less than that of the first optical component and the total area of bonding material which contacts with the first optical component is less than 1.4% of the total surface area of the first optical component.

With reference to FIG. 8B, an exemplary LGP 100 having a thickness of 1.1 mm is illustrated laminated with an optical film 570 such as but not limited to a prism film, for experimentation purposes. The output light of an LED 502 with a width of 1 mm was coupled to the LGP 100 from a light injection edge. The size of the experimental LGP 100 and the optical film 570 are 500 mm×500 mm. Bonding material 504 in the form of OCA dots were uniformly deposited over the interface between the LGP 100 and optical film 570. Minimum distance between two neighbor dots was about 10 mm. Table 1 below shows the refractive indexes of bonding material, LGP, and optical film for several modeling cases.

TABLE 1

| Reflective | Case | Case | Case | Case | Case | Case | Case | Case |
|---|---|---|---|---|---|---|---|---|
| Index | 1 | 2 | 3 | 4 | 5 | 6 | 7 | 8 |
| Bonding | 1.25 | 1.3 | 1.35 | 1.4 | 1.5 | 1.6 | 1.4 | 1.4 |
| material | | | | | | | | |
| LGP | 1.5 | 1.5 | 1.5 | 1.5 | 1.5 | 1.5 | 1.5 | 1.5 |
| Optical | 1.5 | 1.5 | 1.5 | 1.5 | 1.5 | 1.5 | 1.6 | .145 |
| Film | | | | | | | | |

FIG. 9 is a graphical depiction of power coupled from an exemplary LGP to an optical film as a function of the ratio of total bonding area to LGP area for certain bonding material refractive indices and (1.25, 1.30, 1.35) and LGP and optical film refractive indices (1.5). With reference to FIG. 9, curves of the power coupled from an LGP to optical film as a function of the ratio of total bonding material area to LGP area for cases 1-3 are illustrated (see Table 1). It can be observed that the percentage of the power coupled from an LGP to optical film increases with the increasing of the ratio of total bonding material area to LGP area for all three cases. However, for case 1, the percentage of the power coupled from an LGP to optical film saturates at approximately 7% when the ratio of total bonding material area to LGP area is larger than 0.1.

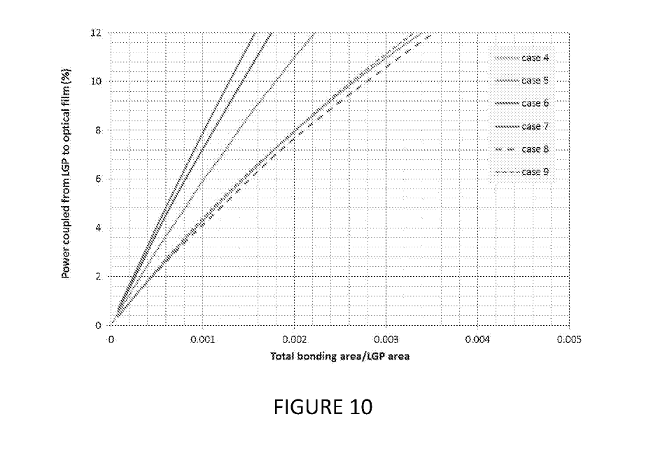

FIG. 10 is a graphical depiction of power coupled from LGP to optical film as a function of the ratio of total bonding area to LGP area for other bonding material, LGP, and optical film refractive indices. With reference to FIG. 10, curves of the power coupled from an LGP to optical film as a function of the ratio of total bonding material area to LGP area for cases 4-9 are illustrated (see Table 1). With reference to FIGS. 9 and 10, the following results can be observed. First, the power coupled from the LGP to the optical film decreases with the decreasing of the refractive index of bonding material (see cases 1-6). Second, the most light is coupled from LGP to optical film when the refractive indexes of LGP, bonding material, and optical film are the same (see case 6). Third, the impact of the refractive index of optical film on the coupled power is small enough to be ignored when the refractive index of bonding material is smaller than that of LGP (see cases 4, 8, and 9). Fourth, the case of bonding material refractive index being lower than LGP is better than the case of bonding material refractive index being higher than LGP (see cases 4 and 7).

Exemplary widths and heights of the LGP generally depend upon the size of the respective LCD panel. It should be noted that embodiments of the present subject matter are applicable to any size LCD panel whether small (<40″ diagonal) or large (>40″ diagonal) displays. Exemplary dimensions for LGPs include, but are not limited to, 20″, 30″, 40″, 50″, 60″ diagonal or more.

Color Shift Compensation

In prior glasses although decreasing iron concentration minimized absorption and yellow shift, it was difficult to eliminate it completely. The Δx, Δy in the measured for PMMA for a propagation distance of about 700 mm was 0.0021 and 0.0063. In exemplary glasses having the compositional ranges described herein, the color shift Δy was <0.015 and in exemplary embodiments was less than 0.0021, and less than 0.0063. For example, in some embodiments, the color shift was measured as 0.007842 and in other embodiments was measured as 0.005827. In other embodiments, an exemplary glass sheet can comprise a color shift Δy less than 0.015, such as ranging from about 0.001 to about 0.015 (e.g., about 0.001, 0.002, 0.003, 0.04, 0.005, 0.006, 0.007, 0.008, 0.009, 0.010, 0.011, 0.012, 0.013, 0.014, or 0.015). In other embodiments, the transparent substrate can comprise a color shift less than 0.008, less than about 0.005, or less than about 0.003. Color shift may be characterized by measuring variation in the x and/or y chromaticity coordinates along a length L using the CIE 1931 standard for color measurements for a given source illumination. For exemplary glass light-guide plates the color shift Δy can be reported as Δy=y(L₂)−y(L₁) where L₂ and Li are Z positions along the panel or substrate direction away from the source launch (e.g., LED or otherwise) and where L₂−L₁=0.5 meters. Exemplary light-guide plates described herein have Δy<0.015, Δy<0.005, Δy<0.003, or Δy<0.001. The color shift of a light guide plate can be estimated by measuring the optical absorption of the light guide plate, using the optical absorption to calculate the internal transmission of the LGP over 0.5 m, and then multiplying the resulting transmission curve by a typical LED source used in LCD backlights such as the Nichia NFSW157D-E. One can then use the CIE color matching functions to compute the (X, Y, Z) tristimulus values of this spectrum. These values are then normalized by their sum to provide the (x, y) chromaticity coordinates. The difference between the (x, y) values of the LED spectrum multiplied by the 0.5 m LGP transmission and the (x, y) values of the original LED spectrum is the estimate of the color shift contribution of the light guide material. To address residual color shift, several exemplary solutions may be implemented. In one embodiment, light guide blue painting can be employed. By blue painting the light guide, one can artificially increase absorption in red and green and increase light extraction in blue. Accordingly, knowing how much differential color absorption exists, a blue paint pattern can be back calculated and applied that can compensate for color shift. In one or more embodiments, shallow surface scattering features can be employed to extract light with an efficiency that depends on the wavelength. As an example, a square grating has a maximum of efficiency when the optical path difference equals half of the wavelength. Accordingly, exemplary textures can be used to preferentially extract blue and can be added to the main light extraction texture. In additional embodiments, image processing can also be utilized. For example, an image filter can be applied that will attenuate blue close to the edge where light gets injected. This may require shifting the color of the LEDs themselves to keep the right white color. In further embodiments, pixel geometry can be used to address color shift by adjusting the surface ratio of the RGB pixels in the panel and increasing the surface of the blue pixels far away from the edge where the light gets injected.

### Examples and Glass Compositions

Further to the exemplary compositions the attenuation impact of each element may be estimated by identifying the wavelength in the visible where it attenuates most strongly. In examples shown in Table 2 below, the coefficients of absorption of the various transition metals have been experimentally determined in relation to the concentrations of Al₂O₃ to RₓO (however, only the modifier Na₂O has been shown below for brevity).

TABLE 2

| | | dB/ppm/500 mm | |
|---|---|---|---|
| | Al₂O₃ > Na₂O | Al₂O₃ = Na₂O | Al₂O₃ < Na₂O |
| V | 0.119 | 0.109 | 0.054 |
| Cr | 2.059 | 1.869 | 9.427 |
| Mn | 0.145 | 0.06 | 0.331 |
| Fe | 0.336 | 0.037 | 0.064 |
| Co | 1.202 | 2.412 | 3.7 |
| Ni | 0.863 | 0.617 | 0.949 |
| Cu | 0.108 | 0.092 | 0.11 |

With the exception of V (vanadium), a minimum attenuation is found for glasses with concentrations of Al₂O₃═Na₂O, or more generally for Al₂O₃˜RₓO. In various instances the transition metals may assume two or more valences (e.g., Fe can be both +2 and +3), so to some extent the redox ratio of these various valences may be impacted by the bulk composition. Transition metals respond differently to what are known as “crystal field” or “ligand field” effects that arise from interactions of the electrons in their partially-filled d-orbital with the surrounding anions (oxygen, in this case), particularly if there are changes in the number of anion nearest neighbors (also referred to as coordination number). Thus, it is likely that both redox ratio and crystal field effects contribute to this result.

The coefficients of absorption of the various transition metals may also be utilized to determine the attenuation of the glass composition over a path length in the visible spectrum (i.e., between 380 and 700 nm) and address solarization issues, as shown in Table 3 below and discussed in further detail below.

TABLE 3

| | |
|---|---|
| Al₂O₃ − RₓO = 4 | 0.119V + 2.059Cr + 0.145Mn + 0.336Fe + |
| | 1.202Co + 0.863Ni + 0.108Cu < 2 |
| Al₂O₃~RₓO = 0 | 0.109V + 1.869Cr + 0.06Mn + 0.037Fe + |
| | 2.412Co + 0.617Ni + 0.092Cu < 2 |
| Al₂O₃ < RₓO = −4 | 0.054V + 9.427Cr + 0.331Mn + 0.064Fe + |
| | 3.7Co + 0.949Ni + 0.11Cu < 2 |

Of course the values identified in Table 3 are exemplary only should not limit the scope of the claims appended herewith. For example, it was also unexpectedly discovered that a high transmittance glass could be obtained when Fe+30Cr+35Ni<60 ppm. In some embodiments, the concentration of Fe can be <about 50 ppm, <about 40 ppm, <about 30 ppm, <about 20 ppm, or <about 10 ppm. In other embodiments, Fe+30Cr+35Ni<about 50 ppm, <about 40 ppm, <about 30 ppm, <about 20 ppm, or <about 10 ppm. It was also unexpectedly discovered that the addition of certain transition metal oxides that do not cause absorption from 300 nm to 650 nm and that have absorption bands <about 300 nm will prevent network defects from forming processes and will prevent color centers (e.g., absorption of light from 300 nm to 650 nm) post UV exposure when curing ink since the bond by the transition metal oxide in the glass network will absorb the light instead of allowing the light to break up the fundamental bonds of the glass network. Thus, exemplary embodiments can include any one or combination of the following transition metal oxides to minimize UV color center formation: from about 0.1 mol % to about 3.0 mol % zinc oxide; from about 0.1 mol % to about 1.0 mol % titanium oxide; from about 0.1 mol % to about 1.0 mol % vanadium oxide; from about 0.1 mol % to about 1.0 mol % niobium oxide; from about 0.1 mol % to about 1.0 mol % manganese oxide; from about 0.1 mol % to about 1.0 mol % zirconium oxide; from about 0.1 mol % to about 1.0 mol % arsenic oxide; from about 0.1 mol % to about 1.0 mol % tin oxide; from about 0.1 mol % to about 1.0 mol % molybdenum oxide; from about 0.1 mol % to about 1.0 mol % antimony oxide; from about 0.1 mol % to about 1.0 mol % cerium oxide; and all subranges therebetween of any of the above listed transition metal oxides. In some embodiments, an exemplary glass can contain from 0.1 mol % to less than or no more than about 3.0 mol % of any combination of zinc oxide, titanium oxide, vanadium oxide, niobium oxide, manganese oxide, zirconium oxide, arsenic oxide, tin oxide, molybdenum oxide, antimony oxide, and cerium oxide

Tables 4A, 4B, 5A, and 5B provide some exemplary non-limiting examples of glasses prepared for embodiments of the present subject matter.

TABLE 4A

| | wt % | mol % |
|---|---|---|
| SiO₂ | 66.72 | 77.22 |
| SiO₂ (diff) | 67.003 | |
| Al₂O₃ | 12 | 7.62 |
| B₂O₃ | 8.15 | 7.58 |
| Li₂O | 0 | 0 |
| Na₂O | 7.73 | 8.08 |
| K₂O | 0.013 | 0.01 |
| ZnO | 0 | 0 |
| MgO | 1.38 | 2.22 |
| CaO | 0.029 | 0.03 |
| SrO | 3.35 | 2.09 |
| BaO | | 0.08 |
| SnO₂ | 0.176 | 0.08 |
| Fe₂O₃ | 0.12 | |

TABLE 4B

| | wt % | mol % |
|---|---|---|
| SiO₂ | 74.521 | 76.27 |
| SiO₂ (diff) | 74.431 | |
| Al₂O₃ | 7.214 | 4.36 |
| B₂O₃ | 0 | 0 |
| Li₂O | 0 | 0 |
| Na₂O | 10.197 | 10.13 |
| K₂O | 0.003 | 0 |
| ZnO | 1.577 | 1.19 |
| MgO | 4.503 | 6.88 |
| CaO | 0.03 | 0.03 |
| SrO | 1.69 | 1 |
| BaO | 0.031 | 0.01 |
| SnO₂ | 0.224 | 0.09 |
| Fe₂O₃ | | |

TABLE 5A

| | wt % | mol % |
|---|---|---|
| SiO₂ | 74.749 | 76.37 |
| SiO₂ (diff) | 74.847 | |
| Al₂O₃ | 8.613 | 5.18 |
| B₂O₃ | 0 | 0 |
| Li₂O | 0 | 0 |
| Na₂O | 11.788 | 11.66 |
| K₂O | 0.003 | 0 |
| ZnO | 0 | 0 |
| MgO | 4.344 | 6.61 |
| CaO | 0.027 | 0.03 |
| SrO | 0 | 0 |
| BaO | 0 | 0 |
| SnO₂ | 0.24 | 0.1 |
| Fe₂O₃ | 0.128 | |

TABLE 5B

| | wt % | mol % |
|---|---|---|
| SiO₂ | 73.38 | 76.17 |
| SiO₂ (diff) | 73.823 | |
| Al₂O₃ | 7.15 | 4.35 |
| B₂O₃ | 0 | 0 |
| Li₂O | 0 | 0 |
| Na₂O | 8.55 | 8.56 |
| K₂O | 2.40 | 1.58 |
| ZnO | 1.57 | 1.2 |
| MgO | 4.50 | 6.92 |
| CaO | 0.05 | 0.05 |
| SrO | 1.74 | 1.04 |
| BaO | 0 | 0 |
| SnO₂ | 0.22 | 0.09 |
| Fe₂O₃ | | |

Exemplary compositions as heretofore described can thus be used to achieve a strain point ranging from about 525° C. to about 575° C., from about 540° C. to about 570° C., or from about 545° C. to about 565° C. and all subranges therebetween. In one embodiment, the strain point is about 547° C., and in another embodiment, the strain point is about 565° C. An exemplary annealing point can range from about 575° C. to about 625° C., from about 590° C. to about 620° C., and all subranges therebetween. In one embodiment, the annealing point is about 593° C., and in another embodiment, the annealing point is about 618° C. An exemplary softening point of a glass ranges from about 800° C. to about 890° C., from about 820° C. to about 880° C., or from about 835° C. to about 875° C. and all subranges therebetween. In one embodiment, the softening point is about 836.2° C., in another embodiment, the softening point is about 874.7° C. The density of exemplary glass compositions can range from about 1.95 gm/cc @ 20 C to about 2.7 gm/cc @ 20 C, from about 2.1 gm/cc @ 20 C to about 2.4 gm/cc @ 20 C, or from about 2.3 gm/cc @ 20 C to about 2.4 gm/cc @ 20 C and all subranges therebetween. In one embodiment the density is about 2.389 gm/cc @ 20 C, and in another embodiment the density is about 2.388 gm/cc @20 C. CTEs (0-300° C.) for exemplary embodiments can range from about 30×10-7/° C. to about 95×10-7/° C., from about 50×10-7/° C. to about 80×10-7/° C., or from about 55×10-7/° C. to about 80×10-7/° C. and all subranges therebetween. In one embodiment the CTE is about 55.7×10-7/° C. and in another embodiment the CTE is about 69×10-7/° C.

Certain embodiments and compositions described hereinhave provided an internal transmission from 400-700 nm greater than 90%, greater than 91%, greater than 92%, greater than 93%, greater than 94%, and even greater than 95%. Internal transmittance can be measured by comparing the light transmitted through a sample to the light emitted from a source. Broadband, incoherent light may be cylindrically focused on the end of the material to be tested. The light emitted from the far side may be collected by an integrating sphere fiber coupled to a spectrometer and forms the sample data. Reference data is obtained by removing the material under test from the system, translating the integrating sphere directly in front of the focusing optic, and collecting the light through the same apparatus as the reference data. The absorption at a given wavelength is then given by:

$$absorption ( dB \text{/} m ) = \frac{- 10 log \frac{{T}_{sample data}}{{T}_{reference data}}}{( {Pathlength}_{sample data} - {Pathlength}_{reference data} )}$$

The internal transmittance over 0.5 m is given by:

Transmittance(%)=100×10^{-absorption×0.5/10}

Thus, exemplary embodiments described herein can have an internal transmittance at 450 nm with 500 mm in length of greater than 85%, greater than 90%, greater than 91%, greater than 92%, greater than 93%, greater than 94%, and even greater than 95%. Exemplary embodiments described herein can also have an internal transmittance at 550 nm with 500 mm in length of greater than 90%, greater than 91%, greater than 92%, greater than 93%, greater than 94%, and even greater than 96%. Further embodiments described herein can have a transmittance at 630 nm with 500 mm in length of greater than 85%, greater than 90%, greater than 91%, greater than 92%, greater than 93%, greater than 94%, and even greater than 95%.

In one or more embodiments, the LGP has a width of at least about 1270 mm and a thickness of between about 0.5 mm and about 3.0 mm, wherein the transmittance of the LGP is at least 80% per 500 mm. In various embodiments, the thickness of the LGP is between about 1 mm and about 8 mm, and the width of the plate is between about 1100 mm and about 1300 mm.

In one or more embodiments, the LGP can be strengthened. For example, certain characteristics, such as a moderate compressive stress (CS), high depth of compressive layer (DOL), and/or moderate central tension (CT) can be provided in an exemplary glass sheet used for a LGP. One exemplary process includes chemically strengthening the glass by preparing a glass sheet capable of ion exchange. The glass sheet can then be subjected to an ion exchange process, and thereafter the glass sheet can be subjected to an anneal process if necessary. Of course, if the CS and DOL of the glass sheet are desired at the levels resulting from the ion exchange step, then no annealing step is required. In other embodiments, an acid etching process can be used to increase the CS on appropriate glass surfaces. The ion exchange process can involve subjecting the glass sheet to a molten salt bath including KNO₃, preferably relatively pure KNO₃ for one or more first temperatures within the range of about 400-500° C. and/or for a first time period within the range of about 1-24 hours, such as, but not limited to, about 8 hours. It is noted that other salt bath compositions are possible and would be within the skill level of an artisan to consider such alternatives. Thus, the disclosure of KNO₃ should not limit the scope of the claims appended herewith. Such an exemplary ion exchange process can produce an initial CS at the surface of the glass sheet, an initial DOL into the glass sheet, and an initial CT within the glass sheet. Annealing can then produce a final CS, final DOL and final CT as desired.

### Examples

The following examples are set forth below to illustrate the methods and results according to the disclosed subject matter. These examples are not intended to be inclusive of all embodiments of the subject matter disclosed herein, but rather to illustrate representative methods and results. These examples are not intended to exclude equivalents and variations of the present disclosure which are apparent to one skilled in the art.

Efforts have been made to ensure accuracy with respect to numbers (e.g., amounts, temperature, etc.) but some errors and deviations should be accounted for. Unless indicated otherwise, temperature is in ° C. or is at ambient temperature, and pressure is at or near atmospheric. The compositions themselves are given in mole percent on an oxide basis and have been normalized to 100%. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

The glass properties set forth herein and in Table 5 below were determined in accordance with techniques conventional in the glass art. Thus, the linear coefficient of thermal expansion (CTE) over the temperature range 25-300° C. is expressed in terms of ×10-7P/C and the annealing point is expressed in terms of ° C. These were determined from fiber elongation techniques (ASTM references E228-85 and C336, respectively). The density in terms of grams/cm3 was measured via the Archimedes method (ASTM C693). The melting temperature in terms of C (defined as the temperature at which the glass melt demonstrates a viscosity of 200 poises) was calculated employing a Fulcher equation fit to high temperature viscosity data measured via rotating cylinders viscometry (ASTM C965-81).

The liquidus temperature of the glass in terms of ° C. was measured using the standard gradient boat liquidus method of ASTM C829-81. This involves placing crushed glass particles in a platinum boat, placing the boat in a furnace having a region of gradient temperatures, heating the boat in an appropriate temperature region for 24 hours, and determining by means of microscopic examination the highest temperature at which crystals appear in the interior of the glass. More particularly, the glass sample is removed from the Pt boat in one piece, and examined using polarized light microscopy to identify the location and nature of crystals which have formed against the Pt and air interfaces, and in the interior of the sample. Because the gradient of the furnace is very well known, temperature vs. location can be well estimated, within 5-10° C. The temperature at which crystals are observed in the internal portion of the sample is taken to represent the liquidus of the glass (for the corresponding test period). Testing is sometimes carried out at longer times (e.g. 72 hours), to observe slower growing phases. The liquidus viscosity in poises was determined from the liquidus temperature and the coefficients of the Fulcher equation. If included, Young's modulus values in terms of GPa were determined using a resonant ultrasonic spectroscopy technique of the general type set forth in ASTM E1875-00e1.

The exemplary glasses of the tables herein were prepared using a commercial sand as a silica source, milled such that 90% by weight passed through a standard U.S. 100 mesh sieve. Alumina was the alumina source, periclase was the source for MgO, limestone the source for CaO, strontium carbonate, strontium nitrate or a mix thereof was the source for SrO, barium carbonate was the source for BaO, and tin (IV) oxide was the source for SnO₂. The raw materials were thoroughly mixed, loaded into a platinum vessel suspended in a furnace heated by silicon carbide glowbars, melted and stirred for several hours at temperatures between 1600 and 1650° C. to ensure homogeneity, and delivered through an orifice at the base of the platinum vessel. The resulting patties of glass were annealed at or near the annealing point, and then subjected to various experimental methods to determine physical, viscous and liquidus attributes.

These methods are not unique, and the glasses of the tables herein can be prepared using standard methods well-known to those skilled in the art. Such methods include a continuous melting process, such as would be performed in a continuous melting process, wherein the melter used in the continuous melting process is heated by gas, by electric power, or combinations thereof.

Raw materials appropriate for producing exemplary glasses include commercially available sands as sources for SiO2; alumina, aluminum hydroxide, hydrated forms of alumina, and various aluminosilicates, nitrates and halides as sources for Al₂O₃; boric acid, anhydrous boric acid and boric oxide as sources for B2O3; periclase, dolomite (also a source of CaO), magnesia, magnesium carbonate, magnesium hydroxide, and various forms of magnesium silicates, aluminosilicates, nitrates and halides as sources for MgO; limestone, aragonite, dolomite (also a source of MgO), wolastonite, and various forms of calcium silicates, aluminosilicates, nitrates and halides as sources for CaO; and oxides, carbonates, nitrates and halides of strontium and barium. If a chemical fining agent is desired, tin can be added as SnO₂, as a mixed oxide with another major glass component (e.g., CaSnO3), or in oxidizing conditions as SnO, tin oxalate, tin halide, or other compounds of tin known to those skilled in the art.

The glasses in the tables herein can contain SnO₂ as a fining agent, but other chemical fining agents could also be employed to obtain glass of sufficient quality for display applications. For example, exemplary glasses could employ any one or combinations of As2O3, Sb2O3, CeO₂, Fe₂O₃, and halides as deliberate additions to facilitate fining, and any of these could be used in conjunction with the SnO₂ chemical fining agent shown in the examples. Of these, As2O3 and Sb2O3 are generally recognized as hazardous materials, subject to control in waste streams such as might be generated in the course of glass manufacture or in the processing of TFT panels. It is therefore desirable to limit the concentration of As2O3 and Sb2O3 individually or in combination to no more than 0.005 mol %.

In addition to the elements deliberately incorporated into exemplary glasses, nearly all stable elements in the periodic table are present in glasses at some level, either through low levels of contamination in the raw materials, through high-temperature erosion of refractories and precious metals in the manufacturing process, or through deliberate introduction at low levels to fine tune the attributes of the final glass. For example, zirconium may be introduced as a contaminant via interaction with zirconium-rich refractories. As a further example, platinum and rhodium may be introduced via interactions with precious metals. As a further example, iron may be introduced as a tramp in raw materials, or deliberately added to enhance control of gaseous inclusions. As a further example, manganese may be introduced to control color or to enhance control of gaseous inclusions.

Hydrogen is inevitably present in the form of the hydroxyl anion, OH—, and its presence can be ascertained via standard infrared spectroscopy techniques. Dissolved hydroxyl ions significantly and nonlinearly impact the annealing point of exemplary glasses, and thus to obtain the desired annealing point it may be necessary to adjust the concentrations of major oxide components so as to compensate. Hydroxyl ion concentration can be controlled to some extent through choice of raw materials or choice of melting system. For example, boric acid is a major source of hydroxyls, and replacing boric acid with boric oxide can be a useful means to control hydroxyl concentration in the final glass. The same reasoning applies to other potential raw materials comprising hydroxyl ions, hydrates, or compounds comprising physisorbed or chemisorbed water molecules. If burners are used in the melting process, then hydroxyl ions can also be introduced through the combustion products from combustion of natural gas and related hydrocarbons, and thus it may be desirable to shift the energy used in melting from burners to electrodes to compensate. Alternatively, one might instead employ an iterative process of adjusting major oxide components so as to compensate for the deleterious impact of dissolved hydroxyl ions.

Sulfur is often present in natural gas, and likewise is a tramp component in many carbonate, nitrate, halide, and oxide raw materials. In the form of SO2, sulfur can be a troublesome source of gaseous inclusions. The tendency to form SO2-rich defects can be managed to a significant degree by controlling sulfur levels in the raw materials, and by incorporating low levels of comparatively reduced multivalent cations into the glass matrix. While not wishing to be bound by theory, it appears that SO2-rich gaseous inclusions arise primarily through reduction of sulfate (SO4=) dissolved in the glass. The elevated barium concentrations of exemplary glasses appear to increase sulfur retention in the glass in early stages of melting, but as noted above, barium is required to obtain low liquidus temperature, and hence high T35k−Tliq and high liquidus viscosity. Deliberately controlling sulfur levels in raw materials to a low level is a useful means of reducing dissolved sulfur (presumably as sulfate) in the glass. In particular, sulfur is preferably less than 200 ppm by weight in the batch materials, and more preferably less than 100 ppm by weight in the batch materials.

Reduced multivalents can also be used to control the tendency of exemplary glasses to form SO2 blisters. While not wishing to be bound to theory, these elements behave as potential electron donors that suppress the electromotive force for sulfate reduction. Sulfate reduction can be written in terms of a half reaction such as SO4=→SO2+O2+2e− where e− denotes an electron. The “equilibrium constant” for the half reaction is Keq=[SO2][O2][e−]2/[SO4=] where the brackets denote chemical activities. Ideally one would like to force the reaction so as to create sulfate from SO2, O2 and 2e−. Adding nitrates, peroxides, or other oxygen-rich raw materials may help, but also may work against sulfate reduction in the early stages of melting, which may counteract the benefits of adding them in the first place. SO2 has very low solubility in most glasses, and so is impractical to add to the glass melting process. Electrons may be “added” through reduced multivalents. For example, an appropriate electron-donating half reaction for ferrous iron (Fe2+) is expressed as 2Fe2+→2Fe3++2e−

This “activity” of electrons can force the sulfate reduction reaction to the left, stabilizing SO4=in the glass. Suitable reduced multivalents include, but are not limited to, Fe2+, Mn2+, Sn2+, Sb3+, As3+, V3+, Ti3+, and others familiar to those skilled in the art. In each case, it may be important to minimize the concentrations of such components so as to avoid deleterious impact on color of the glass, or in the case of As and Sb, to avoid adding such components at a high enough level so as to complication of waste management in an end-user's process.

In addition to the major oxides components of exemplary glasses, and the minor or tramp constituents noted above, halides may be present at various levels, either as contaminants introduced through the choice of raw materials, or as deliberate components used to eliminate gaseous inclusions in the glass. As a fining agent, halides may be incorporated at a level of about 0.4 mol % or less, though it is generally desirable to use lower amounts if possible to avoid corrosion of off-gas handling equipment. In some embodiments, the concentrations of individual halide elements are below about 200 ppm by weight for each individual halide, or below about 800 ppm by weight for the sum of all halide elements.

In addition to these major oxide components, minor and tramp components, multivalents and halide fining agents, it may be useful to incorporate low concentrations of other colorless oxide components to achieve desired physical, solarization, optical or viscoelastic properties. Such oxides include, but are not limited to, TiO2, ZrO₂, HfO2, Nb2O5, Ta2O5, MoO3, WO3, ZnO, In2O3, Ga2O3, Bi2O3, GeO2, PbO, SeO3, TeO2, Y2O3, La2O3, Gd2O3, and others known to those skilled in the art. By adjusting the relative proportions of the major oxide components of exemplary glasses, such colorless oxides can be added to a level of up to about 2 mol % to 3 mol % without unacceptable impact to annealing point, T35k−Tliq or liquidus viscosity. For example, some embodiments can include any one or combination of the following transition metal oxides to minimize UV color center formation: from about 0.1 mol % to about 3.0 mol % zinc oxide; from about 0.1 mol % to about 1.0 mol % titanium oxide; from about 0.1 mol % to about 1.0 mol % vanadium oxide; from about 0.1 mol % to about 1.0 mol % niobium oxide; from about 0.1 mol % to about 1.0 mol % manganese oxide; from about 0.1 mol % to about 1.0 mol % zirconium oxide; from about 0.1 mol % to about 1.0 mol % arsenic oxide; from about 0.1 mol % to about 1.0 mol % tin oxide; from about 0.1 mol % to about 1.0 mol % molybdenum oxide; from about 0.1 mol % to about 1.0 mol % antimony oxide; from about 0.1 mol % to about 1.0 mol % cerium oxide; and all subranges therebetween of any of the above listed transition metal oxides. In some embodiments, an exemplary glass can contain from 0.1 mol % to less than or no more than about 3.0 mol % of any combination of zinc oxide, titanium oxide, vanadium oxide, niobium oxide, manganese oxide, zirconium oxide, arsenic oxide, tin oxide, molybdenum oxide, antimony oxide, and cerium oxide.

Table 6 shows examples of glasses (samples 1-133) with high transmissibility as described herein.

TABLE 6

| | 1 | 2 | 3 | 4 | 5 | 6 | 7 |
|---|---|---|---|---|---|---|---|
| SiO2 | 73.14 | 77.69 | 68.94 | 76.51 | 77.73 | 68.72 | 74.43 |
| Al2O3 | 6.95 | 3.95 | 9.06 | 3.97 | 4.22 | 9.13 | 6.44 |
| B2O3 | 0 | 0 | 7.21 | 0 | 0 | 7.21 | 3.74 |
| Li2O | 0 | 0.98 | 0 | 0 | 0 | 0 | 0 |
| Na2O | 10.78 | 9.76 | 10.02 | 8.79 | 10.74 | 10.17 | 9.8 |
| K2O | 0 | 0 | 0.6 | 0 | 0.02 | 0.63 | 0 |
| ZnO | 0 | 0.97 | 0 | 0.97 | 0.97 | 0 | 0.01 |
| MgO | 6.01 | 5.5 | 1.99 | 6.61 | 5.79 | 3.04 | 4.39 |
| CaO | 0.04 | 0.03 | 0.04 | 0.04 | 0.03 | 0.92 | 0.03 |
| SrO | 2.96 | 0.99 | 1.99 | 2.98 | 0.37 | 0 | 1.05 |
| BaO | 0 | 0.01 | 0 | 0 | 0 | 0 | 0 |
| SnO2 | 0.07 | 0.09 | 0.1 | 0.09 | 0.09 | 0.09 | 0.08 |
| R2O/Al2O3 | 1.55 | 2.72 | 1.17 | 2.21 | 2.55 | 1.18 | 1.52 |
| (R2O + RO)/Al2O3 | 2.85 | 4.62 | 1.62 | 4.88 | 4.25 | 1.62 | 2.37 |
| R2O − Al2O3 + MgO | −2.18 | 1.29 | −0.43 | −1.79 | 0.75 | −1.37 | −1.03 |
| strain | 580 | 523 | 540 | 575 | 562 | 535 | 559 |
| anneal | 629 | 574 | 584 | 625 | 615 | 581 | 606 |
| soft | 871.4 | 830.8 | 806 | 868.9 | 867.6 | 823 | 841.5 |
| CTE | 68.5 | 64.9 | 66.5 | 61 | 64.5 | 66.6 | 62.4 |
| density | 2.477 | 2.418 | 2.425 | 2.469 | 2.401 | 2.382 | 2.401 |
| strain (bbv) | 574.7 | 522 | 532.2 | 572.1 | 560 | 531.6 | 551.4 |
| anneal (bbv) | 622.9 | 570.7 | 578 | 621 | 609.9 | 578.1 | 599.9 |
| last bbv visc | 12.012 | 12.012 | 611.8 | 12.0259 | 12.0249 | 613.8 | 12.0292 |
| last bbv T | 660.8 | 609.2 | 12.0146 | 659.3 | 648.8 | 12.0317 | 636.6 |
| soft (ppv) | | | | | | | |
| Color shift | | | | 0.005664 | | | 0.007524 |
| Viscosity | | | | | | | |
| A | −2.074 | −2.014 | −1.614 | −1.873 | −1.89 | −1.945 | −1.65 |
| B | 6417.4 | 6566.1 | 5769.2 | 5987.3 | 6330 | 6446.7 | 6045.6 |
| To | 205.2 | 140.9 | 188 | 228.4 | 193.9 | 152.3 | 194.5 |
| T(200P) | 1672 | 1663 | 1662 | 1663 | 1704 | 1671 | 1725 |
| 72 hr gradient boat | | | | | | | |
| Int | 1005 | 1010 | 935 | 1015 | 970 | 965 | 970 |
| int liq visc | 8.91E+05 | 347581.7 | | 5.48E+05 | 1.85E+06 | | 1.40E+06 |

| | 8 | 9 | 10 | 11 | 12 | 13 | 14 |
|---|---|---|---|---|---|---|---|
| SiO2 | 76.23 | 72.53 | 74.49 | 70.26 | 72.16 | 68.99 | 69.58 |
| Al2O3 | 4.38 | 7.67 | 7.13 | 8.66 | 7.68 | 9.01 | 9.72 |
| B2O3 | 0 | 7.59 | 1.88 | 7.59 | 7.63 | 7.18 | 7.48 |
| Li2O | 0 | 0 | 0 | 0 | 0 | 0 | 0 |
| Na2O | 8.13 | 7.75 | 10.09 | 7.79 | 6.98 | 9.05 | 9.2 |
| K2O | 1.96 | 0.01 | 0 | 1.16 | 1.04 | 0.59 | 0.42 |
| ZnO | 1.17 | 0.96 | 0 | 0 | 0 | 0 | 0 |
| MgO | 6.95 | 1.23 | 3.43 | 2.26 | 2.25 | 3.05 | 2.37 |
| CaO | 0.05 | 0.03 | 0.03 | 0.04 | 0.04 | 0.04 | 0.03 |
| SrO | 1.01 | 2.09 | 2.8 | 2.09 | 2.09 | 1.92 | 1.06 |
| BaO | 0 | 0 | 0 | 0 | 0 | 0 | 0 |
| SnO2 | 0.09 | 0.07 | 0.08 | 0.07 | 0.07 | 0.09 | 0.07 |
| R2O/Al2O3 | 2.30 | 1.01 | 1.42 | 1.03 | 1.04 | 1.07 | 0.99 |
| (R2O + RO)/Al2O3 | 4.40 | 1.57 | 2.29 | 1.54 | 1.61 | 1.63 | 1.35 |
| R2O − Al2O3 + MgO | −1.24 | −1.14 | −0.47 | −1.97 | −1.91 | −2.42 | −2.47 |
| strain | 564 | 543 | 567 | 543 | 544 | 547 | 550 |
| anneal | 616 | 589 | 614 | 589 | 591 | 591 | 598 |
| soft | 877.9 | 830.2 | 857.2 | 832.3 | 840.8 | 828.8 | 872.5 |
| CTE | 66.4 | 55.2 | 64.9 | 61.3 | 56.8 | 63.3 | 60.9 |
| density | 2.426 | 2.402 | 2.452 | 2.402 | 2.388 | 2.414 | 2.375 |
| strain (bbv) | 562.1 | 537.7 | 560.5 | 536.5 | 539.6 | 538.5 | 542 |
| anneal (bbv) | 613.5 | 584.9 | 607.9 | 585 | 588.1 | 585.7 | 593.2 |
| last bbv visc | 12.0302 | 12.0236 | 12.0205 | 620.6 | 625.3 | 620.5 | 631.4 |
| last bbv T | 654 | 621.7 | 644.7 | 12.0374 | 12.0301 | 12.0372 | 12.0026 |
| soft (ppv) | | | | | | | |
| Color shift | | | | | | | |
| Viscosity | | | | | | | |
| A | −2.187 | −1.802 | −1.739 | −1.9 | −1.9 | −1.946 | −2.425 |
| B | 6861.1 | 6467.9 | 6089.3 | 6503.7 | 6594.4 | 6398.2 | 7698.3 |
| To | 171.3 | 153.6 | 202 | 152.4 | 149.6 | 162.6 | 97.6 |
| T(200P) | 1700 | 1730 | 1709 | 1701 | 1719 | 1669 | 1727 |
| 72 hr gradient boat | | | | | | | |
| int | 1005 | 935 | 990 | 925 | 930 | 975 | 1010 |
| int liq visc | 1103314 | 2.99E+06 | 9.74E+05 | 3.30E+06 | 3.55E+06 | | 1.03E+06 |

| | 15 | 16 | 17 | 18 | 19 | 20 | 21 |
|---|---|---|---|---|---|---|---|
| SiO2 | 77.04 | 72.25 | 76.05 | 70.31 | 73.35 | 77.66 | 75.15 |
| Al2O3 | 3.67 | 7.65 | 4.5 | 8.68 | 3.97 | 3.95 | 3.98 |
| B2O3 | 1.89 | 7.56 | 0 | 9.51 | 0 | 0 | 0 |
| Li2O | 0 | 0 | 0 | 0 | 0 | 0 | 0 |
| Na2O | 10.64 | 8.08 | 10.02 | 7.81 | 10.84 | 9.25 | 12.86 |
| K2O | 0 | 0.01 | 0 | 1.16 | 0 | 1.44 | 0 |
| ZnO | 0 | 0.96 | 1.76 | 0 | 0 | 0.97 | 0 |
| MgO | 6.58 | 1.72 | 6.51 | 1.24 | 6.73 | 6.57 | 6.79 |
| CaO | 0.03 | 0.03 | 0.03 | 0.03 | 0.04 | 0.03 | 0.03 |
| SrO | 0 | 1.59 | 0.99 | 1.11 | 4.89 | 0 | 1.02 |
| BaO | 0 | 0 | 0 | 0 | 0.03 | 0 | 0.01 |
| SnO2 | 0.08 | 0.08 | 0.1 | 0.08 | 0.09 | 0.09 | 0.1 |
| R2O/Al2O3 | 2.90 | 1.06 | 2.23 | 1.03 | 2.73 | 2.71 | 3.23 |
| (R2O + RO)/Al2O3 | 4.70 | 1.62 | 4.29 | 1.31 | 5.68 | 4.62 | 5.20 |
| R2O − Al2O3 + MgO | 0.39 | −1.28 | −0.99 | −0.95 | 0.14 | 0.17 | 2.09 |
| strain | 544 | 541 | 574.0 | 525 | 538 | 562.0 | 523 |
| anneal | 591 | 587 | 626.0 | 575 | 582 | 616 | 570 |
| soft | 830.3 | 838.8 | 881.6 | 828.4 | 797.6 | 878.9 | 813.2 |
| CTE | 64.2 | 55.1 | 63.9 | 59.7 | 73.5 | 66.3 | 74 |
| density | 2.385 | 2.389 | 2.441 | 2.353 | 2.506 | 2.395 | 2.424 |
| strain (bbv) | 538.6 | 535.7 | 574.1 | 519.4 | 531.7 | 562.6 | 518.2 |
| anneal (bbv) | 585.9 | 583.7 | 623.9 | 568.4 | 576.9 | 614.3 | 564.3 |
| last bbv visc | 12.016 | 12.0317 | 12.0021 | 604.3 | 12.0046 | 12.0158 | 12.0098 |
| last bbv T | 622.7 | 621.2 | 663.8 | 12.031 | 612.4 | 655.4 | 600.2 |
| soft (ppv) | | | | | | | |
| Color shift | | | | | | | |
| Viscosity | | | | | | | |
| A | −1.683 | −2.028 | −1.953 | −1.9 | −1.79 | −2.058 | −1.911 |
| B | 5890.6 | 6953.1 | 6229.6 | 6845.9 | 5350.3 | 6609.3 | 5970.1 |
| To | 192.6 | 126.4 | 217.3 | 111.1 | 224.4 | 185.7 | 171.2 |
| T(200P) | 1671 | 1733 | 1682 | 1741 | 1532 | 1702 | 1589 |
| 72 hr gradient boat | | | | | | | |
| int | 990 | 900 | 1020 | 830 | 890 | 890 | 855 |
| int liq visc | 5.06E+05 | 9.12E+06 | 642403 | 4.20E+07 | 1.77E+06 | 21193919 | 6.60E+06 |

| | 22 | 23 | 24 | 25 | 26 | 27 | 28 |
|---|---|---|---|---|---|---|---|
| SiO2 | 76.88 | 75.67 | 76.97 | 76.15 | 77.64 | 76.27 | 75.22 |
| Al2O3 | 4.18 | 5.79 | 4.68 | 4.61 | 3.96 | 4.36 | 6.94 |
| B2O3 | 0 | 1.75 | 0 | 0 | 0 | 0 | 0 |
| Li2O | 0 | 0 | 0 | 0 | 0 | 0 | 0 |
| Na2O | 11.69 | 10.67 | 8.71 | 9.6 | 10.7 | 10.13 | 12.77 |
| K2O | 0 | 0 | 2.9 | 0 | 0 | 0 | 0 |
| ZnO | 0 | 0.01 | 0 | 1.18 | 0.98 | 1.19 | 0 |
| MgO | 7.08 | 5.44 | 6.59 | 6.94 | 6.08 | 6.88 | 1.93 |
| CaO | 0.03 | 0.03 | 0.03 | 0.03 | 0.03 | 0.03 | 0.03 |
| SrO | 0 | 0.53 | 0 | 0.9 | 0 | 1 | 2.97 |
| BaO | 0 | 0 | 0 | 0.46 | 0.49 | 0.01 | 0 |
| SnO2 | 0.1 | 0.08 | 0.08 | 0.1 | 0.09 | 0.09 | 0.07 |
| R2O/Al2O3 | 2.80 | 1.84 | 2.48 | 2.08 | 2.70 | 2.32 | 1.84 |
| (R2O + RO)/Al2O3 | 4.50 | 2.88 | 3.90 | 4.15 | 4.62 | 4.41 | 2.55 |
| R2O − Al2O3 + MgO | 0.43 | −0.56 | 0.34 | −1.95 | 0.66 | −1.11 | 3.9 |
| strain | 552 | 565 | 549 | 578 | 557 | 573 | 534 |
| anneal | 603 | 613 | 603 | 631 | 609 | 625 | 581 |
| soft | 853.3 | 860.1 | 870.4 | 886.8 | 862.3 | 877.3 | 813.3 |
| CTE | 69.1 | 64.7 | 73.2 | 62.6 | 65 | 63.2 | 74.1 |
| density | 2.386 | 2.398 | 2.385 | 2.446 | 2.414 | 2.428 | 2.468 |
| strain (bbv) | 549.9 | 557.8 | 546.5 | 578.5 | 555.6 | 573.4 | 525.8 |
| anneal (bbv) | 599 | 605.9 | 598.2 | 629.1 | 604.6 | 623.9 | 572.9 |
| last bbv visc | 12.0259 | 12.0026 | 12.0207 | 12.0197 | 12.0072 | 12.0121 | 12.0378 |
| last bbv T | 637 | 643.5 | 638.3 | 669.3 | 643.4 | 663.3 | 608.9 |
| soft (ppv) | | | | | | | |
| Color shift | | 0.006389 | | | | | |
| Viscosity | | | | | | | |
| A | −2.073 | −1.873 | −2.356 | −1.932 | −1.959 | −2.134 | −1.567 |
| B | 6603.1 | 6377.4 | 7386.5 | 6230.8 | 6333.5 | 6554.9 | 5710.6 |
| To | 168.6 | 183.8 | 124.5 | 222.6 | 189.8 | 201 | 189 |
| T(200P) | 1678 | 1712 | 1711 | 1695 | 1677 | 1679 | 1665 |
| 72 hr gradient boat | | | | | | | |
| int | 940 | 950 | 840 | 1050 | 950 | 985 | 960 |
| int liq visc | 3.07E+06 | 2.82E+06 | 9.28E+07 | 3.97E+05 | 2.36E+06 | 1.69E+06 | 6.91E+05 |

| | 29 | 30 | 31 | 32 | 33 | 34 | 35 |
|---|---|---|---|---|---|---|---|
| SiO2 | 77.56 | 72.53 | 77.31 | 72.17 | 68.19 | 72.39 | 72.28 |
| Al2O3 | 3.96 | 6.83 | 4.98 | 7.68 | 10.84 | 7.38 | 7.37 |
| B2O3 | 0 | 9.75 | 0 | 7.63 | 7.37 | 7.45 | 7.34 |
| Li2O | 0 | 0 | 0 | 1.06 | 0 | 0 | 0 |
| Na2O | 10.26 | 6.78 | 11.19 | 6.98 | 10.47 | 8.52 | 8.96 |
| K2O | 0 | 0.01 | 0 | 0.01 | 0.01 | 0 | 0 |
| ZnO | 0.97 | 0 | 0.01 | 0 | 0 | 0 | 0 |
| MgO | 6.61 | 1.96 | 6.37 | 2.24 | 2.42 | 2.09 | 1.99 |
| CaO | 0.03 | 0.04 | 0.03 | 0.03 | 0.04 | 0.02 | 0.02 |
| SrO | 0 | 1.95 | 0 | 2.09 | 0.53 | 2.01 | 1.9 |
| BaO | 0.48 | 0 | 0 | 0 | 0 | 0 | 0 |
| SnO2 | 0.09 | 0.09 | 0.08 | 0.08 | 0.07 | 0.08 | 0.08 |
| R2O/Al2O3 | 2.59 | 0.99 | 2.25 | 1.05 | 0.97 | 1.15 | 1.22 |
| (R2O + RO)/Al2O3 | 4.63 | 1.57 | 3.53 | 1.62 | 1.24 | 1.71 | 1.75 |
| R2O − Al2O3 + MgO | −0.31 | −2 | −0.16 | −1.87 | −2.78 | −0.95 | −0.4 |
| strain | 567 | 535 | 573 | 529 | 553 | 546 | 547 |
| anneal | 619 | 583 | 626 | 576 | 604 | 591 | 591 |
| soft | 872.3 | 835.4 | 880.9 | 826.8 | 881.8 | 823 | 816.4 |
| CTE | 63.5 | 50.2 | 66.5 | 53.7 | 63.2 | 58.4 | 57.1 |
| density | 2.413 | 2.356 | 2.38 | 2.386 | 2.369 | 2.393 | 2.397 |
| strain (bbv) | 561 | 532.7 | 568.6 | 525.3 | 547.8 | 540.8 | 539.9 |
| anneal (bbv) | 612.8 | 681.5 | 619.4 | 571.5 | 600.2 | 587.3 | 585.9 |
| last bbv visc | 12.0281 | 619.3 | 12.0051 | 607.5 | 640.7 | 12.0332 | 12.0107 |
| last bbv T | 652.3 | 12.0096 | 659.5 | 12.0195 | 12.0195 | 623.2 | 622.1 |
| soft (ppv) | | | | | | | |
| Color shift | | | 0.00606 | | | | |
| Viscosity | | | | | | | |
| A | −1.933 | −1.9 | −1.997 | −1.81 | −2.843 | −1.536 | −1.49 |
| B | 6346.9 | 6842.9 | 6560.7 | 6533.2 | 8399.5 | 5834.9 | 5653 |
| To | 197.7 | 129 | 190.9 | 134.7 | 75.5 | 192.8 | 202.9 |
| T(200P) | 1697 | 1758 | 1717 | 1724 | 1708 | 1713 | 1694 |
| 72 hr gradient boat | | | | | | | |
| int | 990 | 930 | 880 | 940 | 1000 | 910 | 920 |
| int liq visc | 1.20E+06 | 4.39E+06 | 3.34E+07 | 2.01E+06 | 1.75E+06 | 3.98E+06 | 2.47E+06 |

| | 36 | 37 | 38 | 39 | 40 | 41 | 42 |
|---|---|---|---|---|---|---|---|
| SiO2 | 73.65 | 75.25 | 76.99 | 75.63 | 76.37 | 73.43 | 75.92 |
| Al2O3 | 7.32 | 5.97 | 3.45 | 5.01 | 5.17 | 6.71 | 4.61 |
| B2O3 | 3.84 | 0.96 | 0 | 1.72 | 0 | 5.61 | 0 |
| Li2O | 0 | 0 | 0 | 0 | 0 | 0 | 0 |
| Na2O | 9.39 | 10.77 | 5.95 | 10.55 | 11.17 | 6.52 | 9.67 |
| K2O | 0 | 0 | 2.03 | 0 | 0 | 0.97 | 0 |
| ZnO | 0 | 0 | 2.91 | 0 | 0 | 0 | 1.2 |
| MgO | 3.05 | 3.84 | 6.56 | 3.88 | 6.11 | 2.47 | 7.01 |
| CaO | 0.03 | 0.03 | 0.03 | 0.03 | 0.03 | 0.87 | 0.03 |
| SrO | 2.58 | 3.03 | 1.95 | 3.04 | 1.01 | 3.25 | 1.41 |
| BaO | 0 | 0 | 0 | 0 | 0 | 0.05 | 0 |
| SnO2 | 0.08 | 0.08 | 0.1 | 0.07 | 0.09 | 0.08 | 0.1 |
| R2O/Al2O3 | 1.28 | 1.80 | 2.31 | 2.11 | 2.16 | 1.12 | 2.10 |
| (R2O + RO)/Al2O3 | 2.06 | 2.96 | 5.63 | 3.49 | 3.54 | 2.11 | 4.19 |
| R2O − Al2O3 + MgO | −0.98 | 0.96 | −2.03 | 1.66 | −0.11 | −1.69 | −1.95 |
| strain | 559 | 551 | 586 | 539 | 561 | 558 | 580 |
| anneal | 606 | 598 | 639 | 585 | 613 | 603 | 632 |
| soft | 843.7 | 832.6 | 898.4 | 806.9 | 865.0 | 57.8 | 885.4 |
| CTE | 61.7 | 67.8 | 59 | 67.1 | 68.2 | 835.9 | 61.8 |
| density | 2.437 | 2.463 | 2.474 | 2.464 | 2.411 | 2.442 | 2.441 |
| strain (bbv) | 552.7 | 545.8 | 586.9 | 532.8 | 560 | 551.9 | 579.8 |
| anneal (bbv) | 600.6 | 593.7 | 638.1 | 577.8 | 609.4 | 599 | 629.8 |
| last bbv visc | 12.0199 | 12.0153 | 12.0022 | 12.0136 | 12.1063 | 12.0089 | 12.0309 |
| last bbv T | 637.5 | 630.8 | 679.1 | 612.5 | 648 | 634.9 | 669.4 |
| soft (ppv) | | | | | | | |
| Color shift | | | | | | | |
| Viscosity | | | | | | | |
| A | −1.753 | −1.659 | −1.98 | −1.563 | −1.949 | −1.721 | −1.92 |
| B | 6249.6 | 5855.6 | 6350.9 | 5507.5 | 6428.1 | 6078.8 | 6206.9 |
| To | 183.5 | 202.4 | 224.9 | 206.6 | 190.5 | 191.9 | 224.4 |
| T(200P) | 1725 | 1681 | 1708 | 1632 | 1703 | 1703 | 1695 |
| 72 hr gradient boat | | | | | | | |
| int | 960 | 935 | 1095 | 890 | 920 | 920 | 1065 |
| int liq visc | 1.97E+06 | 2.16E+06 | 2.08E+05 | 3.13E+06 | 7.29E+06 | 4.24E+06 | 2.91E+05 |
| | 43 | 44 | 45 | 46 | 47 | 48 | 49 |
| SiO2 | 70.93 | 77.84 | 74.12 | 68.66 | 74.36 | 68.62 | 72.25 |
| Al2O3 | 8.63 | 4.35 | 6.06 | 10.09 | 6.45 | 10.06 | 7.65 |
| B2O3 | 7.58 | 0 | 3.78 | 7.25 | 3.86 | 7.29 | 7.56 |
| Li2O | 0 | 0 | 0 | 0 | 0 | 0 | 0 |
| Na2O | 8.08 | 10.65 | 5 | 10.24 | 9.76 | 11.01 | 8.08 |
| K2O | 0.76 | 0 | 1.93 | 0.65 | 0 | 0 | 0.01 |
| ZnO | 0 | 0.96 | 0 | 0 | 0 | 0 | 0.96 |
| MgO | 2.28 | 6.05 | 2.77 | 2.02 | 4.35 | 1.93 | 1.72 |
| CaO | 0.04 | 0.03 | 1.73 | 0.92 | 0.03 | 0.02 | 0.03 |
| SrO | 1.56 | 0 | 4.41 | 0 | 1.04 | 0.93 | 1.59 |
| BaO | 0 | 0 | 0.07 | 0 | 0.01 | 0 | 0 |
| SnO2 | 0.07 | 0.09 | 0.08 | 0.1 | 0.07 | 0.08 | 0.08 |
| R2O/Al2O3 | 1.02 | 2.45 | 1.14 | 1.08 | 1.51 | 1.09 | 1.06 |
| (R2O + RO)/Al2O3 | 1.47 | 4.07 | 2.63 | 1.37 | 2.36 | 1.38 | 1.62 |
| R2O − Al2O3 + MgO | −2.07 | 0.25 | −1.9 | −1.22 | −1.04 | −0.98 | −1.28 |
| strain | 543 | 572 | 572 | 540 | 554 | 553 | 541 |
| anneal | 592 | 625 | 617 | 588 | 601 | 598 | 587 |
| soft | 852.7 | 880.6 | 59.7 | 842.9 | 840.9 | 847.6 | 838.8 |
| CTE | 59.2 | 64.1 | 851.4 | 66.4 | 62 | 65.7 | 55.1 |
| density | 2.382 | 2.392 | 2.485 | 2.373 | 2.405 | 2.387 | 2.389 |
| strain (bbv) | 537.8 | 570.1 | 565.6 | 536.1 | 545.1 | 543 | 535.7 |
| anneal (bbv) | 587.6 | 621 | 613.2 | 585.1 | 593.1 | 591 | 583.7 |
| last bbv visc | 624.4 | 12.0015 | 12.0184 | 621.3 | 12.0279 | 12.0124 | 12.0317 |
| last bbv T | 12.025 | 661.2 | 649.1 | 12.0299 | 629.7 | 628.6 | 621.2 |
| soft (ppv) | | | | | | | |
| Color shift | | | | | | | |
| Viscosity | | | | | | | |
| A | −2.165 | −1.975 | −1.855 | −2.206 | −1.828 | −1.755 | −2.028 |
| B | 7218.9 | 6471.2 | 6197.3 | 7123.4 | 6425.7 | 6217.7 | 6953.1 |
| To | 115.6 | 198.1 | 202.4 | 120.6 | 165.8 | 176.7 | 126.4 |
| T(200P) | 1732 | 1711 | 1694 | 1701 | 1722 | 1710 | 1733 |
| 72 hr gradient boat | | | | | | | |
| int | 960 | 950 | 975 | 920 | 965 | 975 | 900 |
| int liq visc | 2.42E+06 | 4.28E+06 | 1.47E+06 | | 1.63E+06 | 1.08E+06 | 9.12E+06 |
| | 50 | 51 | 52 | 53 | 54 | 55 | 56 |
| SiO2 | 72.23 | 75.59 | 77.16 | 76.9 | 76.55 | 74.95 | 72.58 |
| Al2O3 | 7.62 | 4.99 | 3.95 | 4.68 | 3.97 | 5.43 | 6.98 |
| B2O3 | 9.1 | 1.84 | 0 | 0 | 0 | 1.78 | 7.49 |
| Li2O | 0 | 0 | 0 | 0 | 0 | 0 | 0 |
| Na2O | 7.53 | 5.75 | 10.84 | 11.68 | 9.3 | 3.52 | 8.51 |
| K2O | 0.01 | 4.83 | 0 | 0 | 1.49 | 2.9 | 0 |
| ZnO | 0 | 0 | 0 | 0 | 1.97 | 0 | 0 |
| MgO | 2.24 | 3.84 | 4.86 | 6.57 | 6.56 | 3.08 | 2.19 |
| CaO | 0.03 | 0.03 | 0.03 | 0.03 | 0.03 | 2.6 | 0.02 |
| SrO | 1.09 | 2.99 | 3.01 | 0 | 0 | 5.54 | 2.07 |
| BaO | 0 | 0 | 0 | 0 | 0 | 0.09 | 0 |
| SnO2 | 0.08 | 0.08 | 0.09 | 0.08 | 0.1 | 0.08 | 0.08 |
| R2O/Al2O3 | 0.99 | 2.12 | 2.74 | 2.50 | 2.72 | 1.18 | 1.22 |
| (R2O + RO)/Al2O3 | 1.43 | 3.49 | 4.74 | 3.91 | 4.87 | 3.27 | 1.83 |
| R2O − Al2O3 + MgO | −2.32 | 1.75 | 2.03 | 0.43 | 0.26 | −2.09 | −0.66 |
| strain | 535 | 540 | 528 | 558 | 563 | 590 | 547 |
| anneal | 585 | 586 | 577 | 610 | 616 | 639 | 591 |
| soft | 859.3 | 818.4 | 814.9 | 867.7 | 876.7 | 61.2 | 814.5 |
| CTE | 52.3 | 73.4 | 69.3 | 68.6 | 67.3 | 878.7 | 57.3 |
| density | 2.340 | 2.463 | 2.437 | 2.385 | 2.418 | 2.52 | 2.397 |
| strain (bbv) | 533 | 532.3 | 524 | 554 | 559.9 | 585.9 | 540.2 |
| anneal (bbv) | 584.1 | 579.8 | 570.9 | 604.9 | 611.7 | 635.6 | 585.9 |
| last bbv visc | 621.6 | 12.0024 | 12.0156 | 12.0012 | 12.0115 | 12.004 | 12.028 |
| last bbv T | 12.026 | 616.9 | 607.4 | 644.5 | 652.3 | 673.4 | 621.4 |
| soft (ppv) | | | | | | | |
| Color shift | | | | | | | |
| Viscosity | | | | | | | |
| A | −2.186 | −1.822 | −1.824 | −2.042 | −2.154 | −2.01 | −1.511 |
| B | 7447.2 | 6267.2 | 6020.9 | 6562.4 | 6682.2 | 6255.3 | 5752.6 |
| To | 97.3 | 163.4 | 172.3 | 177.1 | 180.5 | 227 | 196.1 |
| T(200P) | 1757 | 1683 | 1632 | 1688 | 1680 | 1678 | 1705 |
| 72 hr gradient boat | | | | | | | |
| int | 995 | 875 | 950 | 925 | 1040 | 1030 | 880 |
| int liq visc | 1.29E+06 | 9.66E+06 | 8.28E+05 | 5.40E+06 | 4.17E+05 | 6.02E+05 | 7.95E+06 |

| | 57 | 58 | 59 | 60 | 61 | 62 | 63 |
|---|---|---|---|---|---|---|---|
| SiO2 | 72.21 | 76.24 | 72.07 | 78.17 | 76.2 | 76.91 | 68.92 |
| Al2O3 | 7.57 | 5.16 | 7.6 | 3.98 | 5.19 | 5.18 | 11.68 |
| B2O3 | 8.61 | 0 | 7.44 | 0 | 0 | 0.85 | 4.69 |
| Li2O | 0 | 0 | 0 | 0 | 0 | 0 | 0 |
| Na2O | 7.05 | 9.83 | 8.02 | 10.86 | 11.72 | 10.49 | 12.03 |
| K2O | 1.05 | 0 | 0.01 | 0 | 0.01 | 0 | 0.01 |
| ZnO | 0 | 0.01 | 0.49 | 0 | 0 | 0.01 | 0 |
| MgO | 2.25 | 6.6 | 2.16 | 6.82 | 6.15 | 6.43 | 2.49 |
| CaO | 0.03 | 0.03 | 0.03 | 0.03 | 0.04 | 0.03 | 0.04 |
| SrO | 1.09 | 2.01 | 2.03 | 0 | 0.57 | 0 | 0 |
| BaO | 0 | 0 | 0 | 0 | 0 | 0 | 0 |
| SnO2 | 0.08 | 0.07 | 0.08 | 0.08 | 0.09 | 0.08 | 0.1 |
| R2O/Al2O3 | 1.07 | 1.91 | 1.06 | 2.73 | 2.26 | 2.03 | 1.03 |
| (R2O + RO)/Al2O3 | 1.52 | 3.58 | 1.68 | 4.45 | 3.56 | 3.27 | 1.25 |
| R2O − Al2O3 + MgO | −1.72 | −1.93 | −1.73 | 0.06 | 0.39 | −1.12 | −2.13 |
| strain | 534 | 579 | 546 | 559 | 551 | 574 | 570 |
| anneal | 582 | 631 | 593 | 613 | 604 | 625 | 626 |
| soft | 846.6 | 884.8 | 835.8 | 872.1 | 854.1 | 878.8 | 913.3 |
| CTE | 56 | 63.2 | 55.500 | 65 | 69.5 | 63.3 | 68.6 |
| density | 2.351 | 2.43 | 2.396 | 2.375 | 2.398 | 2.38 | 2.382 |
| strain (bbv) | 529.1 | 577.5 | 541.1 | 556.1 | 549 | 573.2 | 567.8 |
| anneal (bbv) | 579.2 | 628.4 | 588.7 | 606.2 | 599.2 | 623.9 | 621.6 |
| last bbv visc | 616.2 | 12.0151 | 12.0045 | 12.0093 | 12.0064 | 12.0321 | 661.9 |
| last bbv T | 12.017 | 667.9 | 626 | 645.3 | 638.9 | 663.5 | 12.0021 |
| soft (ppv) | | | | | | | |
| Color shift | | 0.006504 | | | | 0.007294 | |
| Viscosity | | | | | | | |
| A | −1.929 | −1.989 | −1.876 | −2.061 | −2.032 | −1.911 | −3.038 |
| B | 6970.1 | 6434.3 | 6540.5 | 6732.8 | 6559.5 | 6471.3 | 8948.7 |
| To | 116.2 | 208.5 | 154.5 | 166.8 | 171.6 | 199.3 | 66.9 |
| T(200P) | 1764 | 1708 | 1720 | 1710 | 1685 | 1736 | 1743 |
| 72 hr gradient boat | | | | | | | |
| int | 990 | 1005 | 950 | 980 | 945 | 1000 | 1050 |
| int liq visc | 1.12E+06 | 1.23E+06 | 2.22E+06 | 1.65E+06 | 2.81E+06 | 1.48E+06 | |

| | 64 | 65 | 66 | 67 | 68 | 69 | 70 |
|---|---|---|---|---|---|---|---|
| SiO2 | 68.69 | 76.18 | 69.67 | 68.29 | 72.27 | 72.33 | 76.84 |
| Al2O3 | 10.07 | 4.37 | 9.7 | 10.78 | 7.66 | 7.7 | 4.69 |
| B2O3 | 9.12 | 0 | 7.44 | 7.35 | 7.61 | 7.6 | 0 |
| Li2O | 0 | 0 | 0 | 0 | 0 | 0 | 0 |
| Na2O | 9.44 | 8.94 | 9.54 | 10.17 | 7.95 | 8.12 | 11.68 |
| K2O | 0.56 | 1.19 | 0.05 | 0.26 | 0 | 0 | 0 |
| ZnO | 0 | 1.2 | 0 | 0 | 0 | 0 | 0 |
| MgO | 1.02 | 6.91 | 2.36 | 2.44 | 0 | 1.41 | 6.61 |
| CaO | 0.93 | 0.05 | 0.04 | 0.04 | 0.02 | 1.21 | 0.03 |
| SrO | 0 | 1.04 | 1.06 | 0.53 | 4.35 | 1.47 | 0 |
| BaO | 0 | 0 | 0 | 0 | 0 | 0 | 0 |
| SnO2 | 0.1 | 0.1 | 0.07 | 0.08 | 0.07 | 0.08 | 0.1 |
| R2O/Al2O3 | 0.99 | 2.32 | 0.99 | 0.97 | 1.04 | 1.05 | 2.49 |
| (R2O + RO)/Al2O3 | 1.19 | 4.42 | 1.35 | 1.25 | 1.61 | 1.59 | 3.91 |
| R2O − Al2O3 + MgO | −1.09 | −1.15 | −2.47 | −2.79 | 0.29 | −0.99 | 0.38 |
| strain | 531 | 563 | 550 | 554 | 557 | 554 | 558 |
| anneal | 582 | 615 | 600 | 605 | 601 | 599 | 610 |
| soft | 859 | 871.5 | 878.8 | 881.1 | 814.2 | 834.4 | 862.2 |
| CTE | 62.5 | 66.2 | 60.4 | 63.5 | 57.1 | 55.7 | 68.3 |
| density | 2.343 | 2.428 | 2.376 | 2.369 | 2.454 | 2.382 | 2.386 |
| strain (bbv) | 52.4 | 562.2 | 543.8 | 547.1 | 551 | 548.3 | 555.7 |
| anneal (bbv) | 576.2 | 612.9 | 594.7 | 599.8 | 596.6 | 595.9 | 605.5 |
| last bbv visc | 613.2 | 12.0115 | 634.2 | 639 | 12.1873 | 12.1295 | 12.0229 |
| last bbv T | 12.0131 | 653.4 | 12.0044 | 12.0223 | 628.3 | 630.7 | 644.1 |
| soft (ppv) | | | | | | | |
| Color shift | | | | | | | |
| Viscosity | | | | | | | |
| A | −2.708 | −2.147 | −2.44 | −2.986 | −1.096 | −1.687 | −1.965 |
| B | 8488.2 | 6708.6 | 7713.5 | 8750.3 | 4896.4 | 6247.9 | 6387.6 |
| To | 36.4 | 179.5 | 100.1 | 55.9 | 259.3 | 178.2 | 187.4 |
| T(200P) | 1731 | 1688 | 1727 | 1711 | 1701 | 1745 | 1685 |
| 72 hr gradient boat | | | | | | | |
| int | | 1000 | 1010 | 1020 | 920 | 930 | 915 |
| int liq visc | | 1.07E+06 | 1.09E+06 | 1.23E+06 | 2.07E+06 | 4.20E+06 | 6.52E+06 |

| | 71 | 72 | 73 | 74 | 75 | 76 | 77 |
|---|---|---|---|---|---|---|---|
| SiO2 | 75.46 | 76.22 | 71.9 | 75.36 | 77.57 | 72.11 | 68.75 |
| Al2O3 | 5.78 | 4.95 | 8.56 | 6.98 | 4.15 | 7.71 | 10.1 |
| B2O3 | 1.88 | 0 | 1.93 | 0.85 | 0 | 7.64 | 7.36 |
| Li2O | 0 | 0 | 0 | 0 | 0 | 2.06 | 0 |
| Na2O | 10.75 | 9.84 | 12.43 | 12.28 | 10.5 | 6 | 9.41 |
| K2O | 0 | 0 | 0 | 0 | 0 | 0.01 | 0.56 |
| ZnO | 0 | 0 | 0 | 0 | 0.97 | 0 | 0 |
| MgO | 5.42 | 5.83 | 5.01 | 4.35 | 6.65 | 2.24 | 1.01 |
| CaO | 0.03 | 0.03 | 0.03 | 0.02 | 0.03 | 0.03 | 0.64 |
| SrO | 0.53 | 2.98 | 0 | 0 | 0 | 2.1 | 2.01 |
| BaO | 0.01 | 0 | 0 | 0 | 0 | 0 | 0 |
| SnO2 | 0.08 | 0.07 | 0.11 | 0.11 | 0.09 | 0.08 | 0.09 |
| R2O/Al2O3 | 1.86 | 1.99 | 1.45 | 1.76 | 2.53 | 1.05 | 0.99 |
| (R2O + RO)/Al2O3 | 2.90 | 3.77 | 2.04 | 2.39 | 4.37 | 1.61 | 1.35 |
| R2O − Al2O3 + MgO | −0.45 | −0.94 | −1.14 | 0.95 | −0.3 | −1.88 | −1.14 |
| strain | 556 | 559 | 575 | 567 | 574 | 522 | 546 |
| anneal | 605 | 610 | 624 | 619 | 627 | 566 | 593 |
| soft | 849.3 | 858.6 | 876.6 | 874 | 878.3 | 804.2 | 64.4 |
| CTE | 64.6 | 65.5 | 71.3 | 69.9 | 63.6 | 51.7 | 834.7 |
| density | 2.403 | 2.457 | 2.403 | 2.393 | 2.393 | 2.384 | 2.415 |
| strain (bbv) | 551.8 | 557.3 | 568.9 | 563.8 | 573.5 | 515.1 | 539.5 |
| anneal (bbv) | 599.9 | 606.6 | 619.3 | 614 | 624.7 | 561.1 | 588 |
| last bbv visc | 12.0185 | 12.0236 | 12.0065 | 12.0047 | 12.0322 | 595.6 | 623.9 |
| last bbv T | 637.2 | 644.2 | 658.8 | 653.8 | 664.7 | 12.0044 | 12.0289 |
| soft (ppv) | | | | | | | |
| Color shift | | | | 0.006152 | | | |
| Viscosity | | | | | | | |
| A | −1.897 | −2.051 | −2.111 | −1.692 | −1.65 | −1.745 | −1.964 |
| B | 6438.4 | 6470.3 | 6794.6 | 6145 | 5771.2 | 6354.5 | 6613.2 |
| To | 174.3 | 184.4 | 177.5 | 205 | 242.7 | 133.1 | 150.8 |
| T(200P) | 1708 | 1671 | 1718 | 1744 | 1703 | 1704 | 1701 |
| 72 hr gradient boat | | | | | | | |
| int | 935 | 955 | 1035 | 940 | 985 | 920 | 1010 |
| int liq visc | 3.69E+06 | 2.22E+06 | | | 1.33E+06 | | |

| | 78 | 79 | 80 | 81 | 82 | 83 | 84 |
|---|---|---|---|---|---|---|---|
| SiO2 | 76.78 | 70.16 | 72.2 | 72.3 | 68.51 | 73.05 | 75.19 |
| Al2O3 | 5.14 | 8.97 | 7.66 | 7.19 | 10.74 | 7.5 | 3.98 |
| B2O3 | 0 | 7.22 | 7.61 | 7.53 | 6.43 | 5.62 | 0 |
| Li2O | 0.99 | 0 | 0 | 0 | 0 | 0 | 0 |
| Na2O | 10.52 | 10.47 | 8.05 | 8.05 | 10.77 | 8.72 | 12.83 |
| K2O | 0 | 0.01 | 0.01 | 0.01 | 0 | 0 | 0 |
| ZnO | 0.98 | 0 | 0.97 | 0.95 | 0 | 0 | 0 |
| MgO | 5.45 | 1.99 | 2.23 | 1.72 | 2.33 | 2.61 | 6.78 |
| CaO | 0.03 | 0.03 | 0.03 | 0.03 | 0.02 | 0.02 | 0.03 |
| SrO | 0 | 1.01 | 1.1 | 2.08 | 1.06 | 2.34 | 1.02 |
| BaO | 0 | 0 | 0 | 0 | 0 | 0 | 0.02 |
| SnO2 | 0.1 | 0.08 | 0.08 | 0.07 | 0.07 | 0.08 | 0.1 |
| R2O/Al2O3 | 2.24 | 1.17 | 1.05 | 1.12 | 1.00 | 1.16 | 3.22 |
| (R2O + RO)/Al2O3 | 3.50 | 1.51 | 1.62 | 1.79 | 1.32 | 1.83 | 5.20 |
| R2O − Al2O3 + MgO | 0.92 | −0.48 | −1.83 | −0.85 | −2.3 | −1.39 | 2.07 |
| strain | 543 | 541 | 543 | 542 | 561 | 554 | 523 |
| anneal | 594 | 586 | 590 | 587 | 609 | 600 | 570 |
| soft | 853.9 | 822.3 | 846.3 | 823.3 | 866.2 | 837.9 | 805.2 |
| CTE | 67.3 | 63.6 | 54.8 | 55.1 | 65 | 58 | 74.7 |
| density | 2.401 | 2.389 | 2.376 | 2.407 | 2.393 | 2.414 | 2.424 |
| strain (bbv) | 539 | 533.9 | 535.6 | 535.6 | 554.1 | 547.6 | 517.3 |
| anneal (bbv) | 589.1 | 580.6 | 585.2 | 582.2 | 604.6 | 594.2 | 565.1 |
| last bbv visc | 12.007 | 614.9 | 12.003 | 12.0275 | 12.0335 | 12.025 | 12.0201 |
| last bbv T | 629.2 | 12.012 | 624 | 618.4 | 643.7 | 629.8 | 601.8 |
| soft (ppv) | | | | | | | |
| Color shift | | | | | | | |
| Viscosity | | | | | | | |
| A | −2.068 | −1.733 | −2.352 | −1.688 | −2.408 | −1.767 | −1.953 |
| B | 6741.8 | 6170.8 | 7658.8 | 6157.4 | 7567.5 | 6280.3 | 6035.8 |
| To | 150 | 165.5 | 90.3 | 169.2 | 119.5 | 174.2 | 169.6 |
| T(200P) | 1693 | 1695 | 1736 | 1713 | 1727 | 1718 | 1588 |
| 72 hr gradient boat | | | | | | | |
| int | 905 | 930 | 1005 | 900 | 1030 | 970 | 855 |
| int liq visc | 7.27E+06 | 2.18E+06 | 1.05E+06 | 5.46E+06 | 8.01E+05 | 1.33E+06 | 7.13E+06 |
| | 85 | 86 | 87 | 88 | 89 | 90 | 91 |
| SiO2 | 77.19 | 77.19 | 75.21 | 76.84 | 75.88 | 75.15 | 70.89 |
| Al2O3 | 4.14 | 3.97 | 4.96 | 4.89 | 4.44 | 6.95 | 8.6 |
| B2O3 | 0 | 0 | 0 | 0 | 0 | 0 | 7.41 |
| Li2O | 0 | 0 | 0 | 0 | 0 | 0 | 0 |
| Na2O | 10.81 | 9.87 | 10.83 | 10.89 | 9.27 | 10.84 | 9.4 |
| K2O | 0 | 0 | 0 | 0 | 1.54 | 0 | 0 |
| ZnO | 1.07 | 0 | 0 | 1.18 | 1.48 | 0 | 0 |
| MgO | 6.19 | 6.8 | 5.84 | 6.04 | 7.23 | 3.87 | 2 |
| CaO | 0.03 | 0.03 | 0.03 | 0.03 | 0.03 | 0.03 | 0.02 |
| SrO | 0 | 1.99 | 2.97 | 0 | 0 | 2.98 | 1.52 |
| BaO | 0.45 | 0 | 0 | 0 | 0 | 0.04 | 0 |
| SnO2 | 0.09 | 0.08 | 0.07 | 0.09 | 0.1 | 0.09 | 0.08 |
| R2O/Al2O3 | 2.61 | 2.49 | 2.18 | 2.23 | 2.43 | 1.56 | 1.09 |
| (R2O + RO)/Al2O3 | 4.48 | 4.71 | 3.97 | 3.71 | 4.40 | 2.56 | 1.50 |
| R2O − Al2O3 + MgO | 0.48 | −0.9 | 0.03 | −0.04 | −0.86 | 0.02 | −1.2 |
| strain | 558 | 554 | 547 | 577 | 572 | 572 | 550 |
| anneal | 611 | 606 | 596 | 630 | 626 | 623 | 596 |
| soft | 861.2 | 857.7 | 835.8 | 885.7 | 887.5 | 868.7 | 836.0 |
| CTE | 66.7 | 63.9 | 69 | 65 | 67.9 | 68.1 | 60.7 |
| density | 2.419 | 2.429 | 2.466 | 2.402 | 2.414 | 2.462 | 2.387 |
| strain (bbv) | 558.8 | 551.6 | 544.3 | 572.4 | 571.1 | 567.8 | 544.3 |
| anneal (bbv) | 608.8 | 600.3 | 591.4 | 622.5 | 623.3 | 617.5 | 591.9 |
| last bbv visc | 12.0023 | 12.0263 | 12.0281 | 12.0188 | 12.037 | 12.0284 | 12.009 |
| last bbv T | 648.8 | 637.9 | 627.9 | 661.8 | 663.9 | 656.6 | 629.2 |
| soft (ppv) | | | | | | | |
| Color shift | | | | | | | |
| Viscosity | | | | | | | |
| A | −1.945 | −2.106 | −1.972 | −2.098 | −2.098 | −1.83 | −1.711 |
| B | 6306.1 | 6632.1 | 6181.9 | 6646.1 | 6561.3 | 6211.1 | 6180.4 |
| To | 196.6 | 168.5 | 186.2 | 190.9 | 199.6 | 208.2 | 178.3 |
| T(200P) | 1682 | 1673 | 1633 | 1702 | 1691 | 1712 | 1719 |
| 72 hr gradient boat | | | | | | | |
| int | 935 | 1005 | 930 | 955 | 1075 | 1000 | 940 |
| int liq visc | 3.94E+06 | 6.64E+05 | 2.18E+06 | 3.98E+06 | 2.50E+05 | 1.03E+06 | 2.53E+06 |
| | 92 | 93 | 94 | 95 | 96 | 97 | 98 |
| SiO2 | 69.36 | 76.39 | 77.22 | 75.2 | 72.91 | 73.37 | 76.39 |
| Al2O3 | 9.74 | 5.17 | 6.93 | 6.95 | 7.8 | 7.06 | 5.18 |
| B2O3 | 7.05 | 0 | 0 | 0 | 2.58 | 5.63 | 0 |
| Li2O | 0 | 0 | 0 | 0 | 0 | 0 | 0.96 |
| Na2O | 10.88 | 11.65 | 10.78 | 8.87 | 11.5 | 8.94 | 10.84 |
| K2O | 0 | 0 | 0 | 0 | 0 | 0 | 0 |
| ZnO | 0 | 0 | 0 | 0 | 0 | 0.01 | 0 |
| MgO | 1.91 | 6.11 | 1.95 | 3.88 | 5.03 | 3.3 | 6.47 |
| CaO | 0.9 | 0.03 | 0.03 | 0.03 | 0.03 | 0.03 | 0.03 |
| SrO | 0 | 0.51 | 2.96 | 4.92 | 0 | 1.56 | 0 |
| BaO | 0 | 0 | 0 | 0 | 0 | 0 | 0 |
| SnO2 | 0.08 | 0.1 | 0.07 | 0.07 | 0.1 | 0.08 | 0.1 |
| R2O/Al2O3 | 1.12 | 2.25 | 1.56 | 1.28 | 1.47 | 1.27 | 2.28 |
| (R2O + RO)/Al2O3 | 1.41 | 3.54 | 1.27 | 2.55 | 2.12 | 1.96 | 3.53 |
| R2O − Al2O3 + MgO | −0.77 | 0.37 | 1.9 | −1.96 | −1.33 | −1.42 | 0.15 |
| strain | 547 | 556 | 560 | 590 | 562 | 556 | 542 |
| anneal | 594 | 608 | 611 | 641 | 611 | 602 | 593 |
| soft | 844.3 | 859.0 | 863.6 | 892.5 | 862.5 | 838 | 851.4 |
| CTE | 65.3 | 69.1 | 67.4 | 63.7 | 67.1 | 59 | 67.5 |
| density | 2.371 | 2.4 | 2.448 | 2.503 | 2.393 | 2.397 | 2.388 |
| strain (bbv) | 542.4 | 553.9 | 555.8 | 587.8 | 555.8 | 551.1 | 535.5 |
| anneal (bbv) | 590.1 | 602.6 | 605.6 | 637.8 | 605.8 | 597.7 | 586.9 |
| last bbv visc | 12.0344 | 12.0062 | 12.0251 | 12.0153 | 12.0306 | 12.0236 | 12.0311 |
| last bbv T | 627.1 | 641 | 644.4 | 676.7 | 643.8 | 633.9 | 626.3 |
| soft (ppv) | | | | | | | |
| Color shift | | | | | | 0.007476 | |
| Viscosity | | | | | | | |
| A | −1.969 | −1.99 | −1.703 | −1.899 | −2.078 | −1.901 | −1.995 |
| B | 6660.4 | 6544.9 | 6317.9 | 6249.2 | 6854.1 | 6483.7 | 6573.3 |
| To | 151.2 | 173.3 | 184.1 | 227.5 | 157.9 | 168.1 | 157.5 |
| T(200P) | 1711 | 1699 | 1762 | 1715 | 1723 | 1711 | 1688 |
| 72 hr gradient boat | | | | | | | |
| int | 950 | 945 | 970 | 1030 | 1035 | 955 | 955 |
| int liq visc | 2.34E+06 | 3.10E+06 | 2.17E+06 | 7.73E+05 | | 2.18E+06 | 1.77E+06 |

| | 99 | 100 | 101 | 102 | 103 | 104 | 105 |
|---|---|---|---|---|---|---|---|
| SiO2 | 75.12 | 69.44 | 77.42 | 72.76 | 76.17 | 70.67 | 75.99 |
| Al2O3 | 6.97 | 9.75 | 3.94 | 5.01 | 4.35 | 8.25 | 4.61 |
| B2O3 | 0 | 6.48 | 0 | 8.32 | 0 | 8.43 | 0 |
| Li2O | 0 | 0 | 0 | 0 | 0 | 0 | 0 |
| Na2O | 12.81 | 10.79 | 9.86 | 4.14 | 8.56 | 7.12 | 11.25 |
| K2O | 0 | 0 | 0 | 0.97 | 1.58 | 1.04 | 0 |
| ZnO | 0 | 0 | 0.97 | 0 | 1.2 | 0 | 1.47 |
| MgO | 3.93 | 2.31 | 6.64 | 4.31 | 6.92 | 2.22 | 6.51 |
| CaO | 0.03 | 0.02 | 0.03 | 0.05 | 0.05 | 0.04 | 0.03 |
| SrO | 1 | 1.06 | 1 | 4.27 | 1.04 | 2.08 | 0 |
| BaO | 0 | 0 | 0 | 0 | 0 | 0 | 0 |
| SnO2 | 0.07 | 0.07 | 0.09 | 0.09 | 0.09 | 0.07 | 0.1 |
| R2O/Al2O3 | 1.84 | 1.11 | 2.50 | 1.02 | 2.33 | 0.99 | 2.44 |
| (R2O + RO)/Al2O3 | 2.55 | 1.45 | 4.70 | 2.74 | 4.45 | 1.52 | 4.18 |
| R2O − Al2O3 + MgO | 1.91 | −1.27 | −0.72 | −4.21 | −1.13 | −2.31 | 0.13 |
| strain | 555 | 555 | 573 | 560 | 562 | 540 | 569 |
| anneal | 603 | 600 | 624 | 604 | 614 | 586 | 622 |
| soft | 852.6 | 842.0 | 878.3 | 831.7 | 873.4 | 834.9 | 880.4 |
| CTE | 72.9 | 65.1 | 61.9 | 49.6 | 67.6 | 57.7 | 66.7 |
| density | 2.42 | 2.394 | 2.416 | 2.433 | 2.428 | 2.387 | 2.414 |
| strain (bbv) | 549 | 547.5 | 565.6 | 556.7 | 558.9 | 535.2 | 565.7 |
| anneal (bbv) | 598.3 | 595.7 | 616.3 | 605.8 | 610.7 | 583.8 | 616.4 |
| last bbv visc | 12.032 | 12.0213 | 12.0121 | 641.9 | 12.014 | 619.5 | 12.016 |
| last bbv T | 636.5 | 633.4 | 655.5 | 12.0273 | 651.5 | 12.0244 | 656 |
| soft (ppv) | | | | | | | |
| Color shift | | | 0.005265 | | | | |
| Viscosity | | | | | | | |
| A | −1.844 | −1.974 | −2.029 | −1.718 | −2.199 | −1.884 | −1.992 |
| B | 6349.3 | 6617.5 | 6515.2 | 5894.9 | 6826.5 | 6635.5 | 6312 |
| To | 178.9 | 160.3 | 191.4 | 212.6 | 171.2 | 142.2 | 205.3 |
| T(200P) | 1711 | 1708 | 1696 | 1679 | 1688 | 1728 | 1676 |
| 72 hr gradient boat | | | | | | | |
| int | 970 | 970 | 1015 | 1000 | 970 | 935 | 960 |
| int liq visc | 1.52E+06 | 1.58E+06 | 7.61E+05 | | 2.22E+06 | 3.06E+06 | 2.35E+06 |

| | 106 | 107 | 108 | 109 | 110 | 111 | 112 |
|---|---|---|---|---|---|---|---|
| SiO2 | 77.22 | 67.94 | 75.19 | 76.35 | 75.87 | 76.28 | 77.09 |
| Al2O3 | 3.96 | 10.68 | 6.93 | 5.21 | 4 | 4.89 | 3.98 |
| B2O3 | 0 | 7.19 | 0 | 0 | 0 | 0 | 0 |
| Li2O | 0 | 0 | 0 | 0 | 0 | 0 | 0 |
| Na2O | 10.91 | 10.88 | 10.81 | 11.55 | 9.7 | 11.24 | 10.88 |
| K2O | 0 | 0.01 | 0 | 0.01 | 0 | 0 | 0 |
| ZnO | 0.97 | 0 | 0 | 0 | 2.48 | 1.21 | 0 |
| MgO | 6.77 | 2.32 | 1.95 | 5.67 | 6.78 | 6.23 | 6.85 |
| CaO | 0.03 | 0.04 | 0.03 | 0.07 | 0.03 | 0.03 | 0.03 |
| SrO | 0 | 0.81 | 4.96 | 1.01 | 1.01 | 0 | 1.03 |
| BaO | 0 | 0 | 0 | 0 | 0 | 0 | 0 |
| SnO2 | 0.09 | 0.07 | 0.07 | 0.1 | 0.1 | 0.09 | 0.1 |
| R2O/Al2O3 | 2.76 | 1.02 | 1.56 | 2.22 | 2.43 | 2.30 | 2.73 |
| (R2O + RO)/Al2O3 | 4.72 | 1.32 | 2.56 | 3.51 | 5.00 | 3.83 | 4.72 |
| R2O − Al2O3 + MgO | 0.18 | −2.11 | 1.93 | 0.68 | −1.08 | 0.12 | 0.05 |
| strain | 566 | 547 | 555 | 547 | 575 | 571 | 549 |
| anneal | 618 | 596 | 603 | 598 | 626 | 625 | 599 |
| soft | 874 | 856.8 | 839 | 852 | 873.3 | 877.4 | 847.3 |
| CTE | 65.4 | 65.2 | 70.7 | 70 | 62.7 | 67.4 | 66.5 |
| density | 2.396 | 2.386 | 2.507 | 2.408 | 2.454 | 2.406 | 2.403 |
| strain (bbv) | 567.1 | 542 | 548.3 | 545.6 | 573.4 | 568.4 | 544.9 |
| anneal (bbv) | 617.3 | 591.2 | 596.8 | 595.1 | 623.5 | 619.7 | 593.9 |
| last bbv visc | 12.0035 | 627.7 | 12.0071 | 12.0146 | 12.0268 | 12.032 | 12.039 |
| last bbv T | 657 | 12.006 | 634.3 | 634.2 | 662.9 | 659.1 | 631.4 |
| soft (ppv) | | | | | | | |
| Color shift | 0.004932 | | | | | | |
| Viscosity | | | | | | | |
| A | −1.856 | −2.605 | −1.587 | −1.876 | −1.874 | −2.588 | −1.976 |
| B | 6077.3 | 7862.2 | 5648.3 | 6262.9 | 5984 | 7841.8 | 6357.2 |
| To | 218.4 | 89.5 | 218.6 | 183.2 | 232.3 | 83.7 | 177.7 |
| T(200P) | 1680 | 1692 | 1671 | 1683 | 1666 | 1688 | 1664 |
| 72 hr gradient boat | | | | | | | |
| int | 960 | 975 | 990 | 945 | 1055 | 945 | 950 |
| int liq visc | 2.18E+06 | 1.88E+06 | 5.43E+05 | 2.21E+06 | 2.51E+05 | 3.29E+06 | 1.80E+06 |

| | 113 | 114 | 115 | 116 | 117 | 118 | 119 |
|---|---|---|---|---|---|---|---|
| SiO2 | 69.17 | 72.45 | 77.4 | 74.55 | 72.35 | 75.95 | 73.14 |
| Al2O3 | 8.97 | 7.6 | 4.14 | 6.83 | 7.63 | 4.49 | 7.05 |
| B2O3 | 7.25 | 7.44 | 0 | 7.75 | 8.03 | 0 | 5.84 |
| Li2O | 0 | 0 | 0 | 0 | 0 | 0 | 0 |
| Na2O | 10.45 | 8.04 | 10.85 | 6.77 | 7.47 | 10.18 | 8.94 |
| K2O | 0.01 | 0 | 0 | 0.01 | 0.01 | 0 | 0 |
| ZnO | 0 | 0 | 0.97 | 0 | 0 | 1.09 | 0 |
| MgO | 2.95 | 0 | 5.99 | 1.95 | 2.23 | 7.02 | 3.29 |
| CaO | 0.04 | 0.02 | 0.03 | 0.04 | 0.03 | 0.03 | 0.03 |
| SrO | 1.01 | 0 | 0.5 | 1.95 | 2.09 | 1.11 | 1.57 |
| BaO | 0 | 4.3 | 0 | 0 | 0 | 0 | 0.02 |
| SnO2 | 0.08 | 0.08 | 0.09 | 0.09 | 0.07 | 0.1 | 0.08 |
| R2O/Al2O3 | 1.17 | 1.06 | 2.62 | 0.99 | 0.98 | 1.27 | 1.27 |
| (R2O + RO)/Al2O3 | 1.61 | 1.63 | 4.43 | 1.57 | 1.55 | 4.33 | 1.96 |
| R2O − Al2O3 + MgO | −1.46 | 0.44 | 0.72 | −2 | −2.38 | −1.33 | −1.4 |
| strain | 541 | 559 | 561 | 547 | 547 | 573 | 552 |
| anneal | 586 | 601 | 612 | 598 | 595 | 624 | 597 |
| soft | 825 | 801.3 | 870.6 | 861.6 | 854.2 | 876.9 | 838.1 |
| CTE | 63.9 | 58.8 | 65.3 | 49.8 | 53 | 63.8 | 58.2 |
| density | 2.396 | 2.530 | 2.407 | 2.361 | 2.378 | 2.432 | 2.402 |
| strain (bbv) | 535.1 | 552.1 | 557.4 | 544.8 | 541.6 | 572.4 | 543.1 |
| anneal (bbv) | 581.6 | 597 | 607.5 | 593.9 | 590.2 | 622.5 | 589.6 |
| last bbv visc | 615.2 | 12.1676 | 12.0084 | 630.3 | 627.9 | 12.0276 | 12.0186 |
| last bbv T | 12.0429 | 628.8 | 647 | 12.0077 | 12.0224 | 662 | 625.5 |
| soft (ppv) | | | | | | | |
| Color shift | | | 0.004576 | | | | |
| Viscosity | | | | | | | |
| A | −1.784 | −0.961 | −1.889 | −2.1 | −2.075 | −2.016 | −1.808 |
| B | 6176.7 | 4553 | 6216.6 | 7434.6 | 7048 | 6405.8 | 6390.8 |
| To | 168.2 | 281.5 | 199.6 | 105.8 | 127.6 | 205.8 | 163 |
| T(200P) | 1680 | 1677 | 1683 | 1795 | 1738 | 1690 | 1718 |
| 72 hr gradient boat | | | | | | | |
| int | 940 | 875 | 950 | 945 | 970 | 1015 | 985 |
| int liq visc | 1.66E+06 | 5.13E+06 | 2.49E+06 | 5.74E+06 | 1.96E+06 | 7.95E+05 | 9.26E+05 |

| | 120 | 121 | 122 | 123 | 124 | 125 | 126 |
|---|---|---|---|---|---|---|---|
| SiO2 | 72.43 | 72.05 | 70.11 | 70.93 | 72.09 | 76.38 | 73.24 |
| Al2O3 | 7.63 | 7.49 | 9.14 | 8.67 | 8.71 | 5.17 | 6.95 |
| B2O3 | 7.47 | 7.41 | 7.31 | 7.52 | 7.69 | 0 | 0 |
| Li2O | 0 | 0 | 0 | 0 | 1.23 | 0 | 0 |
| Na2O | 8.04 | 7.93 | 10.11 | 8.79 | 7.86 | 11.16 | 12.77 |
| K2O | 0 | 0.01 | 0 | 0.01 | 0.01 | 0 | 0 |
| ZnO | 0 | 0.96 | 0 | 0 | 0 | 0 | 0 |
| MgO | 0.04 | 2.04 | 1.95 | 2.32 | 1.22 | 6.6 | 3.9 |
| CaO | 4.24 | 0.03 | 0.02 | 0.04 | 0.02 | 0.03 | 0.03 |
| SrO | 0 | 1.92 | 1.21 | 1.57 | 1.06 | 0.51 | 2.98 |
| BaO | 0 | 0 | 0 | 0 | 0 | 0 | 0 |
| SnO2 | 0.08 | 0.08 | 0.07 | 0.08 | 0.08 | 0.1 | 0.07 |
| R2O/Al2O3 | 1.05 | 1.06 | 1.11 | 1.01 | 1.04 | 2.16 | 1.84 |
| (R2O + RO)/Al2O3 | 1.61 | 1.72 | 1.45 | 1.47 | 1.31 | 3.54 | 2.83 |
| R2O − Al2O3 + MgO | 0.37 | −1.59 | −0.98 | −2.19 | −0.83 | −0.61 | 1.92 |
| strain | 565 | 543 | 549 | 549 | 522 | 566 | 543 |
| anneal | 608 | 589 | 595 | 596 | 569 | 619 | 590 |
| soft | 834.5 | 835.2 | 833.1 | 859.5 | 831.8 | 873.9 | 824 |
| CTE | 56.5 | 54.3 | 62.6 | 58.2 | 55.8 | 67.5 | 75.7 |
| density | 2.372 | 2.401 | 2.386 | 2.382 | 2.357 | 2.399 | 2.48 |
| strain (bbv) | 559.6 | 538 | 590 | 542.5 | 523 | 564.2 | 539.7 |
| anneal (bbv) | 507.4 | 585.8 | 541.9 | 591.4 | 571.6 | 614.5 | 586.7 |
| last bbv visc | 12.2374 | 12.0134 | 12.0101 | 629.2 | 609.5 | 12.0077 | 12.0222 |
| last bbv T | 639.1 | 623.1 | 627.4 | 12.0272 | 12.0178 | 653.6 | 623.6 |
| soft (ppv) | | | | | | | |
| Color shift | | | | | | | |
| Viscosity | | | | | | | |
| A | 71.14 | −1.928 | −1.78 | −2.072 | −1.893 | −2.035 | −1.734 |
| B | 5209.2 | 6686.9 | 6250.3 | 6986.5 | 6912 | 6543 | 5749.3 |
| To | 253.5 | 143.2 | 173.7 | 133.5 | 112.3 | 187.6 | 205.4 |
| T(200P) | 1704 | 1724 | 1705 | 1731 | 1760 | 1697 | 1630 |
| 72 hr gradient boat | | | | | | | |
| int | 980 | 935 | 950 | 980 | 910 | 950 | 970 |
| int liq visc | 7.59E+05 | 3.29E+06 | 1.87E+06 | 1.52E+06 | 5.91E+06 | 3.52E+06 | 6.10E+05 |

| | 127 | 128 | 129 | 130 | 131 | 132 | 133 |
|---|---|---|---|---|---|---|---|
| SiO2 | 77.49 | 75.95 | 77.67 | 76.16 | 76.23 | 77.56 | 76.37 |
| Al2O3 | 4.68 | 4.91 | 4.34 | 4.36 | 4.37 | 3.96 | 5.18 |
| B2O3 | 0 | 0 | 0 | 0 | 0 | 0 | 0 |
| Li2O | 0 | 0 | 0 | 0 | 0 | 0 | 0 |
| Na2O | 10.76 | 11.24 | 10.74 | 9.58 | 8.32 | 9.33 | 11.66 |
| K2O | 0 | 0 | 0 | 0.58 | 1.75 | 1.46 | 0 |
| ZnO | 0.97 | 1.48 | 0.97 | 1.2 | 1.18 | 0 | 0 |
| MgO | 5.94 | 6.25 | 5.88 | 6.89 | 6.94 | 6.75 | 6.61 |
| CaO | 0.03 | 0.03 | 0.03 | 0.05 | 0.05 | 0.03 | 0.03 |
| SrO | 0 | 0 | 0.25 | 1.05 | 1.02 | 0.79 | 0 |
| BaO | 0 | 0 | 0 | 0 | 0 | 0 | 0 |
| SnO2 | 0.09 | 0.1 | 0.09 | 0.1 | 0.09 | 0.09 | 0.01 |
| R2O/Al2O3 | 2.30 | 2.29 | 2.47 | 2.33 | 2.30 | 2.72 | 2.25 |
| (R2O + RO)/Al2O3 | 3.78 | 3.87 | 4.12 | 4.44 | 4.41 | 4.64 | |
| R2O − Al2O3 + MgO | 0.14 | 0.08 | 0.52 | −1.09 | −1.24 | 0.08 | |
| strain | 575 | 573 | 568 | 566 | 564 | 548 | 565 |
| anneal | 628 | 626 | 621 | 616 | 616 | 601 | 618 |
| soft | 886.8 | 883.3 | 876.7 | 868.1 | 878.9 | 858.1 | 874.7 |
| CTE | 64.8 | 66.4 | 64.9 | 64.9 | 66.9 | 68.4 | 69 |
| density | 2.394 | 2.413 | 2.398 | 2.428 | 2.426 | 2.399 | 2.388 |
| strain (bbv) | 572.5 | 571.9 | 564.8 | 561.9 | 561.7 | 546.5 | 564.6 |
| anneal (bbv) | 624.8 | 621.8 | 616.6 | 612.5 | 613.3 | 598.2 | 614.8 |
| last bbv visc | 12.0168 | 12.0291 | 12.0234 | 12.0218 | 12.0076 | 12.0149 | 12.0076 |
| last bbv T | 665.4 | 660.4 | 656.4 | 652.5 | 654.2 | 638.3 | 654 |
| soft (ppv) | | | | | | | |
| Color shift | 0.005485 | | | | | | |
| Viscosity | | | | | | | |
| A | −1.869 | −1.867 | −1.804 | −2.03 | −2.074 | −1.966 | −1.989 |
| B | 6229.9 | 6132.6 | 6165.5 | 6430.3 | 6603.1 | 6524.4 | 6450.8 |
| To | 216.6 | 219.2 | 210.5 | 194.8 | 185.3 | 171.6 | 192.9 |
| T(200P) | 1711 | 1691 | 1712 | 1680 | 1695 | 1701 | 1697 |
| 72 hr gradient boat | | | | | | | |
| int | 955 | 970 | 955 | 990 | 990 | 880 | 935 |
| int liq visc | 3.70E+06 | 2.00E+06 | 3.00E+06 | 1.14E+06 | 1.35E+06 | 1.75E+07 | 5.05E+06 |

Additional examples can include the following compositions in mol %:

| | | | | | | | |
|---|---|---|---|---|---|---|---|
| SiO₂ | 71.86 | 73 | 63-81 | 64-80 | 68-75 | 67 | 71 |
| Al₂O₃ | 0.08 | 0.05 | 0-2 | 0-5 | 0-3 | 0 | 0.09 |
| MgO | 5.64 | 0.22 | 0-6 | 0-10 | 2-6 | 14 | 6 |
| CaO | 9.23 | 10.9 | 7-14 | 2-15 | 6-11 | 6 | 9 |
| SrO | 0.00 | 0.23 | 0-2 | | | | |
| Li₂O or | 0.00 | 0.002 | 0-2 | | | | |
| Li₂O₅ | | | | | | | |
| Na₂O | 13.13 | 14.91 | 9-15 | 9-18 | 11-15 | 13 | 13 |
| K₂O | 0.02 | 0.012 | 0-1.5 | 0-5 | 0-3 | 0.02 | 0.02 |
| Fe₂O₃ | 0.04 | 0.016 | 0-0.6 | | | | |
| Cr₂O₃ | 0.00 | 0.00 | 0-0.2 | | | | |
| MnO₂ | 0.00 | 0.00 | 0-0.2 | | | | |
| Co₃O₄ | 0.00 | 0.00 | 0-0.1 | | | | |
| TiO₂ | 0.01 | 0.008 | 0-0.8 | | | | |
| SO₃ | 0.00 | 0.078 | 0-0.2 | 0-05-0.4 | 0.1-0.4 | | |
| Se | 0.00 | 0.00 | 0-0.1 | | | | |

Some embodiments described herein are directed to a method of manufacturing a backlight unit comprising the steps of providing a first optical component having a first major face and a second major face and laminating the first optical component to a third major face of a second optical component using a discontinuous bonding material, the third major face opposing the first major face of the first optical component. In some embodiments, the first optical component is a light guide plate. In some embodiments, the light guide plate comprises a glass or glass-ceramic material. In some embodiments, the glass or glass-ceramic material comprises between about 65.79 mol % to about 78.17 mol % SiO₂, between about 2.94 mol % to about 12.12 mol % Al₂O₃, between about 0 mol % to about 11.16 mol % B₂O₃, between about 0 mol % to about 2.06 mol % Li₂O, between about 3.52 mol % to about 13.25 mol % Na₂O, between about 0 mol % to about 4.83 mol % K₂O, between about 0 mol % to about 3.01 mol % ZnO, between about 0 mol % to about 8.72 mol % MgO, between about 0 mol % to about 4.24 mol % CaO, between about 0 mol % to about 6.17 mol % SrO, between about 0 mol % to about 4.3 mol % BaO, and between about 0.07 mol % to about 0.11 mol % SnO₂. In some embodiments, the glass or glass-ceramic material comprises between about 66 mol % to about 78 mol % SiO₂, between about 4 mol % to about 11 mol % Al₂O₃, between about 4 mol % to about 11 mol % B₂O₃, between about 0 mol % to about 2 mol % Li₂O, between about 4 mol % to about 12 mol % Na₂O, between about 0 mol % to about 2 mol % K₂O, between about 0 mol % to about 2 mol % ZnO, between about 0 mol % to about 5 mol % MgO, between about 0 mol % to about 2 mol % CaO, between about 0 mol % to about 5 mol % SrO, between about 0 mol % to about 2 mol % BaO, and between about 0 mol % to about 2 mol % SnO₂. In some embodiments, the glass or glass-ceramic material comprises between about 72 mol % to about 80 mol % SiO₂, between about 3 mol % to about 7 mol % Al₂O₃, between about 0 mol % to about 2 mol % B₂O₃, between about 0 mol % to about 2 mol % Li₂O, between about 6 mol % to about 15 mol % Na₂O, between about 0 mol % to about 2 mol % K₂O, between about 0 mol % to about 2 mol % ZnO, between about 2 mol % to about 10 mol % MgO, between about 0 mol % to about 2 mol % CaO, between about 0 mol % to about 2 mol % SrO, between about 0 mol % to about 2 mol % BaO, and between about 0 mol % to about 2 mol % SnO₂. In some embodiments, the glass or glass-ceramic material comprises between about 60 mol % to about 80 mol % SiO₂, between about 0 mol % to about 15 mol % Al₂O₃, between about 0 mol % to about 15 mol % B₂O₃, and about 2 mol % to about 50 mol % RₓO, wherein R is any one or more of Li, Na, K, Rb, Cs and x is 2, or Zn, Mg, Ca, Sr or Ba and x is 1, and wherein Fe+30Cr+35Ni<about 60 ppm. In some embodiments, the glass or glass-ceramic material comprises between about 60 mol % to about 80 mol % SiO₂, between about 0 mol % to about 15 mol % Al₂O₃, between about 0 mol % to about 15 mol % B₂O₃, and about 2 mol % to about 50 mol % RₓO, wherein R is any one or more of Li, Na, K, Rb, Cs and x is 2, or Zn, Mg, Ca, Sr or Ba and x is 1, and wherein the glass has a color shift <0.005. In some embodiments, the glass or glass-ceramic material comprises between about 60 mol % to about 81 mol % SiO₂, between about 0 mol % to about 2 mol % Al₂O₃, between about 0 mol % to about 15 mol % MgO, between about 0 mol % to about 2 mol % Li₂O, between about 9 mol % to about 15 mol % Na₂O, between about 0 mol % to about 1.5 mol % K₂O, between about 7 mol % to about 14 mol % CaO, between about 0 mol % to about 2 mol % SrO, and wherein Fe+30Cr+35Ni<about 60 ppm. In some embodiments, the glass or glass-ceramic material comprises between about 60 mol % to about 81 mol % SiO₂, between about 0 mol % to about 2 mol % Al₂O₃, between about 0 mol % to about 15 mol % MgO, between about 0 mol % to about 2 mol % Li₂O, between about 9 mol % to about 15 mol % Na₂O, between about 0 mol % to about 1.5 mol % K₂O, between about 7 mol % to about 14 mol % CaO, and between about 0 mol % to about 2 mol % SrO, wherein the glass has a color shift <0.005. In some embodiments, the second optical component is a film. In some embodiments, the film is a prism film, a reflective film, a diffusing film, a brightness enhancing film, a polarizing film, or combinations thereof. In some embodiments, the step of laminating includes depositing bonding material in a pattern on the first major face or the third major face, the pattern being a uniform distribution, a non-uniform distribution, or a gradient distribution of bonding material. In some embodiments, the bonding material is an optically clear adhesive or a frit. In some embodiments, the refractive index of the bonding material is smaller than a refractive index of the first optical component. In some embodiments, the refractive index of bonding material is 3% less than a refractive index of the first optical component and total bonding material area which contacts with the first optical component is less than 0.18% of total surface area of the first major face. In some embodiments, the refractive index of bonding material is 6% less than a refractive index of the first optical component and total bonding material area which contacts with the first optical component is less than 0.25% of total surface area of the first major face. In some embodiments, the refractive index of bonding material is 10% less than a refractive index of the first optical component and total bonding material area which contacts with the first optical component is less than 0.45% of total surface area of the first major face. In some embodiments, the refractive index of bonding material is 13% less than a refractive index of the first optical component and total bonding material area which contacts with the first optical component is less than 1.4% of the total surface area of the first major face.

Further embodiments described herein are directed to a backlight unit comprising a first optical component having a first major face and a second major face, a second optical component laminated having a third major face and a fourth major face, wherein the first and third major faces oppose each other, and a discontinuous bonding material deposited between the first and third major faces, the bonding material laminating the first and second optical components. In some embodiments, the first optical component is a light guide plate. In some embodiments, light guide plate comprises a glass or glass-ceramic material. In some embodiments, the glass or glass-ceramic material comprises between about 65.79 mol % to about 78.17 mol % SiO₂, between about 2.94 mol % to about 12.12 mol % Al₂O₃, between about 0 mol % to about 11.16 mol % B₂O₃, between about 0 mol % to about 2.06 mol % Li₂O, between about 3.52 mol % to about 13.25 mol % Na₂O, between about 0 mol % to about 4.83 mol % K₂O, between about 0 mol % to about 3.01 mol % ZnO, between about 0 mol % to about 8.72 mol % MgO, between about 0 mol % to about 4.24 mol % CaO, between about 0 mol % to about 6.17 mol % SrO, between about 0 mol % to about 4.3 mol % BaO, and between about 0.07 mol % to about 0.11 mol % SnO₂. In some embodiments, the glass or glass-ceramic material comprises between about 66 mol % to about 78 mol % SiO₂, between about 4 mol % to about 11 mol % Al₂O₃, between about 4 mol % to about 11 mol % B₂O₃, between about 0 mol % to about 2 mol % Li₂O, between about 4 mol % to about 12 mol % Na₂O, between about 0 mol % to about 2 mol % K₂O, between about 0 mol % to about 2 mol % ZnO, between about 0 mol % to about 5 mol % MgO, between about 0 mol % to about 2 mol % CaO, between about 0 mol % to about 5 mol % SrO, between about 0 mol % to about 2 mol % BaO, and between about 0 mol % to about 2 mol % SnO₂. In some embodiments, the glass or glass-ceramic material comprises between about 72 mol % to about 80 mol % SiO₂, between about 3 mol % to about 7 mol % Al₂O₃, between about 0 mol % to about 2 mol % B₂O₃, between about 0 mol % to about 2 mol % Li₂O, between about 6 mol % to about 15 mol % Na₂O, between about 0 mol % to about 2 mol % K₂O, between about 0 mol % to about 2 mol % ZnO, between about 2 mol % to about 10 mol % MgO, between about 0 mol % to about 2 mol % CaO, between about 0 mol % to about 2 mol % SrO, between about 0 mol % to about 2 mol % BaO, and between about 0 mol % to about 2 mol % SnO₂. In some embodiments, the glass or glass-ceramic material comprises between about 60 mol % to about 80 mol % SiO₂, between about 0 mol % to about 15 mol % Al₂O₃, between about 0 mol % to about 15 mol % B₂O₃, and about 2 mol % to about 50 mol % RₓO, wherein R is any one or more of Li, Na, K, Rb, Cs and x is 2, or Zn, Mg, Ca, Sr or Ba and x is 1, and wherein Fe+30Cr+35Ni<about 60 ppm. In some embodiments, the glass or glass-ceramic material comprises between about 60 mol % to about 80 mol % SiO₂, between about 0 mol % to about 15 mol % Al₂O₃, between about 0 mol % to about 15 mol % B₂O₃, and about 2 mol % to about 50 mol % RₓO, wherein R is any one or more of Li, Na, K, Rb, Cs and x is 2, or Zn, Mg, Ca, Sr or Ba and x is 1, and wherein the glass has a color shift <0.005. In some embodiments, the glass or glass-ceramic material comprises between about 60 mol % to about 81 mol % SiO₂, between about 0 mol % to about 2 mol % Al₂O₃, between about 0 mol % to about 15 mol % MgO, between about 0 mol % to about 2 mol % Li₂O, between about 9 mol % to about 15 mol % Na₂O, between about 0 mol % to about 1.5 mol % K₂O, between about 7 mol % to about 14 mol % CaO, between about 0 mol % to about 2 mol % SrO, and wherein Fe+30Cr+35Ni <about 60 ppm. In some embodiments, the glass or glass-ceramic material comprises between about 60 mol % to about 81 mol % SiO₂, between about 0 mol % to about 2 mol % Al₂O₃, between about 0 mol % to about 15 mol % MgO, between about 0 mol % to about 2 mol % Li₂O, between about 9 mol % to about 15 mol % Na₂O, between about 0 mol % to about 1.5 mol % K₂O, between about 7 mol % to about 14 mol % CaO, and between about 0 mol % to about 2 mol % SrO, wherein the glass has a color shift <0.005. In some embodiments, the second optical component is a film. In some embodiments, the film is a prism film, a reflective film, a diffusing film, a brightness enhancing film, a polarizing film, or combinations thereof. In some embodiments, the discontinuous bonding material is contained in a uniform distribution, a non-uniform distribution, or a gradient distribution between the first and third major faces. In some embodiments, the bonding material is an optically clear adhesive or a frit. In some embodiments, the refractive index of the bonding material is smaller than a refractive index of the first optical component. In some embodiments, the refractive index of bonding material is 3% less than a refractive index of the first optical component and total bonding material area which contacts with the first optical component is less than 0.18% of total surface area of the first major face. In some embodiments, the refractive index of bonding material is 6% less than a refractive index of the first optical component and total bonding material area which contacts with the first optical component is less than 0.25% of total surface area of the first major face. In some embodiments, the refractive index of bonding material is 10% less than a refractive index of the first optical component and total bonding material area which contacts with the first optical component is less than 0.45% of total surface area of the first major face. In some embodiments, the refractive index of bonding material is 13% less than a refractive index of the first optical component and total bonding material area which contacts with the first optical component is less than 1.4% of the total surface area of the first major face.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a ring” includes examples having two or more such rings unless the context clearly indicates otherwise. Likewise, a “plurality” or an “array” is intended to denote “more than one.” As such, a “plurality of droplets” includes two or more such droplets, such as three or more such droplets, etc., and an “array of rings” comprises two or more such droplets, such as three or more such rings, etc.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, such as within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a device that comprises A+B+C include embodiments where a device consists of A+B+C and embodiments where a device consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

1. A method of manufacturing a backlight unit comprising the steps of:
providing a first optical component having a first major face and a second major face; and
laminating the first optical component to a third major face of a second optical component using a discontinuous bonding material, the third major face opposing the first major face of the first optical component.

2. The method of claim 1, wherein the first optical component is a light guide plate.

3. The method of claim 2, wherein the light guide plate comprises a glass or glass-ceramic material.

4. The method of claim 3, wherein the glass or glass-ceramic material comprises:
between about 65.79 mol % to about 78.17 mol % SiO₂,
between about 2.94 mol % to about 12.12 mol % Al₂O₃,
between about 0 mol % to about 11.16 mol % B₂O₃,
between about 0 mol % to about 2.06 mol % Li₂O,
between about 3.52 mol % to about 13.25 mol % Na₂O,
between about 0 mol % to about 4.83 mol % K₂O,
between about 0 mol % to about 3.01 mol % ZnO,
between about 0 mol % to about 8.72 mol % MgO,
between about 0 mol % to about 4.24 mol % CaO,
between about 0 mol % to about 6.17 mol % SrO,
between about 0 mol % to about 4.3 mol % BaO, and
between about 0.07 mol % to about 0.11 mol % SnO₂.

5. The method of claim 3, wherein the glass or glass-ceramic material comprises:
between about 66 mol % to about 78 mol % SiO2,
between about 4 mol % to about 11 mol % Al₂O₃,
between about 4 mol % to about 11 mol % B₂O₃,
between about 0 mol % to about 2 mol % Li₂O,
between about 4 mol % to about 12 mol % Na₂O,
between about 0 mol % to about 2 mol % K₂O,
between about 0 mol % to about 2 mol % ZnO,
between about 0 mol % to about 5 mol % MgO,
between about 0 mol % to about 2 mol % CaO,
between about 0 mol % to about 5 mol % SrO,
between about 0 mol % to about 2 mol % BaO, and
between about 0 mol % to about 2 mol % SnO₂.

6. The method of claim 3, wherein the glass or glass-ceramic material comprises:
between about 72 mol % to about 80 mol % SiO₂,
between about 3 mol % to about 7 mol % Al₂O₃,
between about 0 mol % to about 2 mol % B₂O₃,
between about 0 mol % to about 2 mol % Li₂O,
between about 6 mol % to about 15 mol % Na₂O,
between about 0 mol % to about 2 mol % K₂O,
between about 0 mol % to about 2 mol % ZnO,
between about 2 mol % to about 10 mol % MgO,
between about 0 mol % to about 2 mol % CaO,
between about 0 mol % to about 2 mol % SrO,
between about 0 mol % to about 2 mol % BaO, and
between about 0 mol % to about 2 mol % SnO₂.

7. The method of claim 3, wherein the glass or glass-ceramic material comprises:
between about 60 mol % to about 80 mol % SiO₂,
between about 0 mol % to about 15 mol % Al₂O₃,
between about 0 mol % to about 15 mol % B₂O₃, and
about 2 mol % to about 50 mol % RₓO,
wherein R is any one or more of Li, Na, K, Rb, Cs and x is 2, or Zn, Mg, Ca, Sr or Ba and x is 1, and
wherein Fe+30Cr+35Ni<about 60 ppm.

8. The method of claim 3, wherein the glass or glass-ceramic material comprises:
between about 60 mol % to about 80 mol % SiO2,
between about 0 mol % to about 15 mol % Al₂O₃,
between about 0 mol % to about 15 mol % B₂O₃, and
about 2 mol % to about 50 mol % RₓO,
wherein R is any one or more of Li, Na, K, Rb, Cs and x is 2, or Zn, Mg, Ca, Sr or Ba and x is 1, and
wherein the glass has a color shift <0.005.

9. The method of claim 3, wherein the glass or glass-ceramic material comprises:
between about 60 mol % to about 81 mol % SiO₂,
between about 0 mol % to about 2 mol % Al₂O₃,
between about 0 mol % to about 15 mol % MgO,
between about 0 mol % to about 2 mol % Li₂O,
between about 9 mol % to about 15 mol % Na₂O,
between about 0 mol % to about 1.5 mol % K₂O,
between about 7 mol % to about 14 mol % CaO,
between about 0 mol % to about 2 mol % SrO, and
wherein Fe+30Cr+35Ni<about 60 ppm.

10. The method of claim 3, wherein the glass or glass-ceramic material comprises:
between about 60 mol % to about 81 mol % SiO₂,
between about 0 mol % to about 2 mol % Al₂O₃,
between about 0 mol % to about 15 mol % MgO,
between about 0 mol % to about 2 mol % Li₂O,
between about 9 mol % to about 15 mol % Na₂O,
between about 0 mol % to about 1.5 mol % K₂O,
between about 7 mol % to about 14 mol % CaO, and
between about 0 mol % to about 2 mol % SrO,
wherein the glass has a color shift <0.005.

11. The method of claim 1, wherein the second optical component is a film.

12. The method of claim 11, wherein the film is a prism film, a reflective film, a diffusing film, a brightness enhancing film, a polarizing film, or combinations thereof.

13. The method of claim 1, wherein the step of laminating includes depositing bonding material in a pattern on the first major face or the third major face, the pattern being a uniform distribution, a non-uniform distribution, or a gradient distribution of bonding material.

14. The method of claim 1, wherein the bonding material is an optically clear adhesive or a frit.

15. The method of claim 1, wherein the refractive index of the bonding material is smaller than a refractive index of the first optical component.

16-38. (canceled)

39. The method of claim 1, wherein the refractive index of bonding material is 3% less than a refractive index of the first optical component and total bonding material area which contacts with the first optical component is less than 0.18% of total surface area of the first major face.

40. The method of claim 1, wherein the refractive index of bonding material is 6% less than a refractive index of the first optical component and total bonding material area which contacts with the first optical component is less than 0.25% of total surface area of the first major face.

41. The method of claim 1, wherein the refractive index of bonding material is 10% less than a refractive index of the first optical component and total bonding material area which contacts with the first optical component is less than 0.45% of total surface area of the first major face.

42. The method of claim 1, wherein the refractive index of bonding material is 13% less than a refractive index of the first optical component and total bonding material area which contacts with the first optical component is less than 1.4% of the total surface area of the first major face.

43. A backlight unit comprising:
a first optical component having a first major face and a second major face;
a second optical component laminated having a third major face and a fourth major face, wherein the first and third major faces oppose each other; and
a discontinuous bonding material deposited between the first and third major faces, the bonding material laminating the first and second optical components.

44. The backlight unit of claim 43, wherein the first optical component is a light guide plate.

45. The backlight unit of claim 43, wherein the light guide plate comprises a glass or glass-ceramic material.

46. The backlight unit of claim 43, wherein the glass or glass-ceramic material comprises:
between about 65.79 mol % to about 78.17 mol % SiO₂,
between about 2.94 mol % to about 12.12 mol % Al₂O₃,
between about 0 mol % to about 11.16 mol % B₂O₃,
between about 0 mol % to about 2.06 mol % Li₂O,
between about 3.52 mol % to about 13.25 mol % Na₂O,
between about 0 mol % to about 4.83 mol % K₂O,
between about 0 mol % to about 3.01 mol % ZnO,
between about 0 mol % to about 8.72 mol % MgO,
between about 0 mol % to about 4.24 mol % CaO,
between about 0 mol % to about 6.17 mol % SrO,
between about 0 mol % to about 4.3 mol % BaO, and
between about 0.07 mol % to about 0.11 mol % SnO₂.

47. The backlight unit of claim 43, wherein the glass or glass-ceramic material comprises:
between about 66 mol % to about 78 mol % SiO₂,
between about 4 mol % to about 11 mol % Al₂O₃,
between about 4 mol % to about 11 mol % B₂O₃,
between about 0 mol % to about 2 mol % Li₂O,
between about 4 mol % to about 12 mol % Na₂O,
between about 0 mol % to about 2 mol % K₂O,
between about 0 mol % to about 2 mol % ZnO,
between about 0 mol % to about 5 mol % MgO,
between about 0 mol % to about 2 mol % CaO,
between about 0 mol % to about 5 mol % SrO,
between about 0 mol % to about 2 mol % BaO, and
between about 0 mol % to about 2 mol % SnO₂.

48. The backlight unit of claim 43, wherein the glass or glass-ceramic material comprises:
between about 72 mol % to about 80 mol % SiO₂,
between about 3 mol % to about 7 mol % Al₂O₃,
between about 0 mol % to about 2 mol % B₂O₃,
between about 0 mol % to about 2 mol % Li₂O,
between about 6 mol % to about 15 mol % Na₂O,
between about 0 mol % to about 2 mol % K₂O,
between about 0 mol % to about 2 mol % ZnO,
between about 2 mol % to about 10 mol % MgO,
between about 0 mol % to about 2 mol % CaO,
between about 0 mol % to about 2 mol % SrO,
between about 0 mol % to about 2 mol % BaO, and
between about 0 mol % to about 2 mol % SnO₂.

49. The backlight unit of claim 43, wherein the glass or glass-ceramic material comprises:
between about 60 mol % to about 80 mol % SiO₂,
between about 0 mol % to about 15 mol % Al₂O₃,
between about 0 mol % to about 15 mol % B₂O₃, and
about 2 mol % to about 50 mol % RₓO,
wherein R is any one or more of Li, Na, K, Rb, Cs and x is 2, or Zn, Mg, Ca, Sr or Ba and x is 1, and
wherein Fe+30Cr+35Ni<about 60 ppm.

50. The backlight unit of claim 43, wherein the glass or glass-ceramic material comprises:
between about 60 mol % to about 80 mol % SiO₂,
between about 0 mol % to about 15 mol % Al₂O₃,
between about 0 mol % to about 15 mol % B₂O₃, and
about 2 mol % to about 50 mol % RₓO,
wherein R is any one or more of Li, Na, K, Rb, Cs and x is 2, or Zn, Mg, Ca, Sr or Ba and x is 1, and
wherein the glass has a color shift <0.005.

51. The backlight unit of claim 43, wherein the glass or glass-ceramic material comprises:
between about 60 mol % to about 81 mol % SiO₂,
between about 0 mol % to about 2 mol % Al₂O₃,
between about 0 mol % to about 15 mol % MgO,
between about 0 mol % to about 2 mol % Li₂O,
between about 9 mol % to about 15 mol % Na₂O,
between about 0 mol % to about 1.5 mol % K₂O,
between about 7 mol % to about 14 mol % CaO,
between about 0 mol % to about 2 mol % SrO, and
wherein Fe+30Cr+35Ni<about 60 ppm.

52. The backlight unit of claim 43, wherein the glass or glass-ceramic material comprises:
between about 60 mol % to about 81 mol % SiO₂,
between about 0 mol % to about 2 mol % Al₂O₃,
between about 0 mol % to about 15 mol % MgO,
between about 0 mol % to about 2 mol % Li₂O,
between about 9 mol % to about 15 mol % Na₂O,
between about 0 mol % to about 1.5 mol % K₂O,
between about 7 mol % to about 14 mol % CaO, and
between about 0 mol % to about 2 mol % SrO,
wherein the glass has a color shift <0.005.

53. The backlight unit of claim 43, wherein the second optical component is a film.

54. The backlight unit of claim 53, wherein the film is a prism film, a reflective film, a diffusing film, a brightness enhancing film, a polarizing film, or combinations thereof.

55. The backlight unit of claim 43, wherein the discontinuous bonding material is contained in a uniform distribution, a non-uniform distribution, or a gradient distribution between the first and third major faces.

56. The backlight unit of claim 43, wherein the bonding material is an optically clear adhesive or a frit.

57. The backlight unit of claim 43, wherein the refractive index of the bonding material is smaller than a refractive index of the first optical component.

58. The backlight unit of claim 43, wherein the refractive index of bonding material is 3% less than a refractive index of the first optical component and total bonding material area which contacts with the first optical component is less than 0.18% of total surface area of the first major face.

59. The backlight unit of claim 43, wherein the refractive index of bonding material is 6% less than a refractive index of the first optical component and total bonding material area which contacts with the first optical component is less than 0.25% of total surface area of the first major face.

60. The backlight unit of claim 43, wherein the refractive index of bonding material is 10% less than a refractive index of the first optical component and total bonding material area which contacts with the first optical component is less than 0.45% of total surface area of the first major face.

61. The backlight unit of claim 43, wherein the refractive index of bonding material is 13% less than a refractive index of the first optical component and total bonding material area which contacts with the first optical component is less than 1.4% of the total surface area of the first major face.
